(19) United States
(12) Patent Application Publication
(10) Pub. No.: US 2023/0269722 A1
(43) Pub. Date: Aug. 24, 2023

(54) DOWNLINK CONTROL INFORMATION FOR UNICAST SCHEDULING OF MULTIPLE USER EQUIPMENT

(71) Applicant: QUALCOMM Incorporated, San Diego, CA (US)

(72) Inventors: Huilin XU, Temecula, CA (US); Wanshi CHEN, San Diego, CA (US); Jing LEI, San Diego, CA (US); Yuchul KIM, San Diego, CA (US); Peter GAAL, San Diego, CA (US); Tingfang JI, San Diego, CA (US); Peter Pui Lok ANG, San Diego, CA (US); Qiaoyu LI, Beijing (CN); Yi HUANG, San Diego, CA (US); Yongjun KWAK, San Diego, CA (US); Hwan Joon KWON, San Diego, CA (US); Hung Dinh LY, San Diego, CA (US)

(21) Appl. No.: 18/004,654

(22) PCT Filed: Aug. 6, 2020
(86) PCT No.: PCT/CN2020/107369

§ 371 Date: Jan. 6, 2023

(51) Int. Cl. H04W 72/121; H04W 72/232; H04W 72/0457; H04L 1/1822

(52) U.S. Cl. CPC H04W 72/121; H04W 72/232; H04W 72/0457; H04L 1/1822

(57) ABSTRACT

Methods, systems, and devices for wireless communications are described. In some wireless communications system, a base station may schedule multiple user equipment (UEs) for unicast transmissions using a single downlink control information (DCI) format. For example, a first UE may receive, from a base station, DCI that includes unicast scheduling information for multiple UEs including the first UE. The first UE may determine, from the unicast scheduling information, a set of resources on which to communicate data with the base station. In such cases, the UE may transmit or receive data transmissions using the determined set of resources. In some examples, each UE of the multiple UEs may determine respective sets of resources based on one or more UE-specific transformation rules applied to common scheduling parameters of the DCI.

### CROSS REFERENCE

The present application is a 371 national stage filing of International PCT Application No. PCT/CN2020/107369 by X U et al. entitled “DOWNLINK CONTROL INFORMATION FOR UNICAST SCHEDULING OF MULTIPLE USER EQUIPMENT,” filed Aug. 6, 2020, which is assigned to the assignee hereof, and which is expressly incorporated by reference in its entirety herein.

### TECHNICAL FIELD

The following relates to wireless communications, including downlink control information for unicast scheduling of multiple user equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may schedule a UE for unicast downlink transmissions using downlink control information (DCI). In some examples, DCI may be cyclic redundancy check (CRC) scrambled by a UE-specific radio network temporary identifier (RNTI). Each UE within a cell may be configured with a UE-specific RNTI and may decode DCI having CRC scrambled by their assigned RNTI. However, using separate, UE-specific DCI to schedule multiple UEs (such as in automated deployments (e.g., a smart building)) where data may not be periodic (e.g., not scheduled based on semi-persistent scheduling (SPS)), and may also be relatively small for each UE, may increase signaling overhead and negatively affect system efficiency.

### SUMMARY

The described techniques relate to improved methods, systems, devices, and apparatuses that support downlink control information (DCI) for unicast scheduling of multiple user equipment (UEs). Generally, the described techniques provide for multiple UEs to identify a same DCI and determine resources for unicast downlink transmissions by applying a UE-specific transformation rule to a set of common scheduling parameters included in the DCI. A base station may transmit the DCI, which may be cyclic redundancy check (CRC) scrambled by a UE group-common radio network temporary identifier (RNTI), and the UE group-common RNTI may be assigned to multiple UEs within a cell. As such, the UEs within the cell may recognize and decode the DCI including the unicast scheduling information for multiple UEs. The DCI may include a set of common scheduling parameters, such as time and frequency resource allocation, and the UEs may determine a set of resources for downlink transmissions from the time and frequency resource allocation using one or more transformation rules. In some cases, the network may configure the UE-specific transformation rule(s) for each UE in the cell. Additionally or alternatively, the transformation rule may be a function of the UE's identity.

A method of wireless communication at a first UE is described. The method may include receiving DCI from a base station, the DCI including unicast scheduling information for a set of UEs including the first UE, determining, from the unicast scheduling information, a set of resources for communicating with the base station, and communicating with the base station using the set of resources based on the determination.

An apparatus for wireless communication at a first UE is described. The apparatus may include a processor, memory coupled with the processor, and instructions stored in the memory. The instructions may be executable by the processor to cause the apparatus to receive DCI from a base station, the DCI including unicast scheduling information for a set of UEs including the first UE, determine, from the unicast scheduling information, a set of resources for communicating with the base station, and communicate with the base station using the set of resources based on the determination.

Another apparatus for wireless communication at a first UE is described. The apparatus may include means for receiving DCI from a base station, the DCI including unicast scheduling information for a set of UEs including the first UE, determining, from the unicast scheduling information, a set of resources for communicating with the base station, and communicating with the base station using the set of resources based on the determination.

A non-transitory computer-readable medium storing code for wireless communication at a first UE is described. The code may include instructions executable by a processor to receive DCI from a base station, the DCI including unicast scheduling information for a set of UEs including the first UE, determine, from the unicast scheduling information, a set of resources for communicating with the base station, and communicate with the base station using the set of resources based on the determination.

In some examples of the method, apparatuses, and non-transitory computer-readable medium described herein, determining the set of resources may include operations, features, means, or instructions for determining the set of resources based on one or more predefined rules including a UE-specific transformation of time and frequency resources that may be common across the set of UEs, where the time and frequency resources may be indicated by the DCI.

In some examples of the method, apparatuses, and non-transitory computer-readable medium described herein, the UE-specific transformation includes a shift, a scaling, a modification, or any combination thereof, of the time and frequency resources.

Some examples of the method, apparatuses, and non-transitory computer-readable medium described herein may further include operations, features, means, or instructions for receiving, from the base station, a configuration of the one or more predefined rules, where determining the set of resources may be based on the configuration.

Some examples of the method, apparatuses, and non-transitory computer-readable medium described herein may further include operations, features, means, or instructions for calculating the UE-specific transformation based on an identity of the first UE, an index of a table including a set of candidate transformation values, or any combination thereof.

In some examples of the method, apparatuses, and non-transitory computer-readable medium described herein, the UE-specific transformation includes a function that may be constant over time, variable over time, or any combination thereof.

Some examples of the method, apparatuses, and non-transitory computer-readable medium described herein may further include operations, features, means, or instructions for receiving a message via a physical downlink shared channel (PDSCH) based on the set of resources, and attempting to decode the received message using a scrambling sequence that may be specific to the first UE.

Some examples of the method, apparatuses, and non-transitory computer-readable medium described herein may further include operations, features, means, or instructions for determining that decoding of the received message was unsuccessful based on the attempted decoding, the set of resources at least partially colliding with resources for a second UE of the set of UEs, where the received message may be for the second UE.

Some examples of the method, apparatuses, and non-transitory computer-readable medium described herein may further include operations, features, means, or instructions for decoding the received message using the scrambling sequence, where the received message may be for the first UE.

In some examples of the method, apparatuses, and non-transitory computer-readable medium described herein, determining the set of resources may include operations, features, means, or instructions for identifying one or more candidate shifts that may be specific to the first UE, and determining the set of resources based on the one or more candidate shifts.

Some examples of the method, apparatuses, and non-transitory computer-readable medium described herein may further include operations, features, means, or instructions for receiving, from the base station, a configuration of the one or more candidate shifts, where the one or more candidate shifts may be identified based on the configuration.

In some examples of the method, apparatuses, and non-transitory computer-readable medium described herein, determining the set of resources may include operations, features, means, or instructions for identifying, within the DCI, a bitmap indicating whether messages for the set of UEs may be to be transmitted, the bitmap including respective bit values for each UE of the set of UEs, and determining that a message for the first UE may be to be transmitted on the set of resources based on a bit value from the bitmap that may be associated with the first UE.

In some examples of the method, apparatuses, and non-transitory computer-readable medium described herein, determining the set of resources may include operations, features, means, or instructions for identifying that the first UE may be included in a first UE group from a set of two or more UE groups, where a subset of UEs from the set of UEs included in the first UE group may have non-colliding sets of resources, and determining the set of resources based on the first UE being included in the first UE group.

Some examples of the method, apparatuses, and non-transitory computer-readable medium described herein may further include operations, features, means, or instructions for monitoring a physical downlink control channel (PDCCH) for the DCI based on the first UE being included in the first UE group, where the DCI may be received in a first set of one or more time intervals associated with the first UE group, the first set of one or more time intervals being different from a second set of one or more time intervals associated with a second UE group of the set of two or more UE groups.

Some examples of the method, apparatuses, and non-transitory computer-readable medium described herein may further include operations, features, means, or instructions for identifying, within the DCI, a bitmap indicating that the first UE may be included in the first UE group, the bitmap including respective bit values for UEs associated with each UE group of the set of two or more UE groups, where the respective bit values indicate whether messages for the UEs associated with each UE group may be to be transmitted.

Some examples of the method, apparatuses, and non-transitory computer-readable medium described herein may further include operations, features, means, or instructions for refraining from monitoring for a second DCI based on receiving the DCI, where the DCI and the second DCI may be associated with scheduling unicast repetitions of a message for the first UE, and receiving one or more repetitions of the message based on the received DCI and the set of resources.

Some examples of the method, apparatuses, and non-transitory computer-readable medium described herein may further include operations, features, means, or instructions for receiving a second DCI, where the DCI and the second DCI may be associated with scheduling unicast repetitions of a message for the first UE, and receiving one or more repetitions of the message based on the received DCI, the second DCI, and the set of resources.

Some examples of the method, apparatuses, and non-transitory computer-readable medium described herein may further include operations, features, means, or instructions for determining, based on a decoding failure of a message received on the set of resources, a second set of resources for a retransmission of the message from the base station, where the second set of resources may be different from the set of resources.

In some examples of the method, apparatuses, and non-transitory computer-readable medium described herein, the set of resources may be associated with a first scrambling identifier and the second set of resources may be associated with a second scrambling identifier different from the first scrambling identifier, and where the second set of resources may be the same as the set of resources.

In some examples of the method, apparatuses, and non-transitory computer-readable medium described herein, the second set of resources may be different from the set of resources.

Some examples of the method, apparatuses, and non-transitory computer-readable medium described herein may further include operations, features, means, or instructions for receiving a second DCI that schedules the second set of resources for the retransmission, where the second set of resources may be based on the second DCI.

Some examples of the method, apparatuses, and non-transitory computer-readable medium described herein may further include operations, features, means, or instructions for receiving the retransmission of the message on the second set of resources, where the message may be identified as the retransmission of the message based on decoding the message on the second set of resources.

Some examples of the method, apparatuses, and non-transitory computer-readable medium described herein may further include operations, features, means, or instructions for refraining from soft combining the message and the retransmission of the message based on the set of resources indicating an initial transmission of the message and the second set of resources indicating the retransmission of the message.

Some examples of the method, apparatuses, and non-transitory computer-readable medium described herein may further include operations, features, means, or instructions for performing a hypothetical soft combining of the message and the retransmission of the message.

Some examples of the method, apparatuses, and non-transitory computer-readable medium described herein may further include operations, features, means, or instructions for identifying a switch from a first bandwidth part (BWP) to a second BWP based on the DCI, where each UE of the set of UEs may be switched to the second BWP.

Some examples of the method, apparatuses, and non-transitory computer-readable medium described herein may further include operations, features, means, or instructions for identifying a switch from a first BWP to a second BWP based on the DCI, the DCI including a respective BWP identifier field for each UE of the set of UEs, where the switch from the first BWP may be identified based on a first BWP identifier field corresponding to the first UE.

Some examples of the method, apparatuses, and non-transitory computer-readable medium described herein may further include operations, features, means, or instructions for receiving a second DCI including unicast scheduling information for the first UE, the second DCI triggering a switch from a first BWP to a second BWP, and switching from the first BWP to the second BWP based on the second DCI.

Some examples of the method, apparatuses, and non-transitory computer-readable medium described herein may further include operations, features, means, or instructions for receiving a second DCI including information for a group of UEs from the set of UEs, the second DCI triggering a switch from a first BWP to a second BWP for the group of UEs, and switching from the first BWP to the second BWP based on the second DCI.

Some examples of the method, apparatuses, and non-transitory computer-readable medium described herein may further include operations, features, means, or instructions for monitoring for the DCI within a set of control resources that may be configured across a first BWP and a second BWP, switching from the first BWP to the second BWP, and monitoring for the DCI within the set of control resources based on the switching.

Some examples of the method, apparatuses, and non-transitory computer-readable medium described herein may further include operations, features, means, or instructions for monitoring for the DCI within a first set of control resources that may be associated with a first BWP, switching from the first BWP to a second BWP, and monitoring for the DCI within a second set of control resources associated with the second BWP, where the switching may be based on the second set of control resources of the second BWP used for the DCI.

Some examples of the method, apparatuses, and non-transitory computer-readable medium described herein may further include operations, features, means, or instructions for identifying a transmission configuration indicator (TCI) state that indicates quasi co-location information for communicating with the base station, the quasi co-location information being common across a group of UEs from the set of UEs, where the DCI includes a bitmap indicating whether messages for the group of UEs may be to be transmitted, and where communicating with the base station may be based on the identified TCI state.

Some examples of the method, apparatuses, and non-transitory computer-readable medium described herein may further include operations, features, means, or instructions for identifying, within the DCI, one or more communications parameters for communicating with the base station, where the one or more communications parameters may be indicated within a same field for each UE of the set of UEs, determining UE-specific communications parameters in accordance with at least a portion of a table that may be based on the one or more communications parameters, and communicating with the base station based on the UE-specific communications parameters.

In some examples of the method, apparatuses, and non-transitory computer-readable medium described herein, the one or more communications parameters include a modulation and coding scheme, an antenna port, a virtual resource block to physical resource block mapping, a physical uplink control channel (PUCCH) resource, feedback timing, rate matching information, a zero power channel state information reference signal trigger, or any combination thereof.

In some examples of the method, apparatuses, and non-transitory computer-readable medium described herein, the DCI excludes a transmit power control field, or a counter downlink assignment index field, or any combination thereof.

In some examples of the method, apparatuses, and non-transitory computer-readable medium described herein, determining the set of resources may include operations, features, means, or instructions for identifying, within the DCI, a bitmap indicating whether the set of UEs may be to transmit messages on respective sets of resources, the bitmap including respective bit values for each UE of the set of UEs, and determining that the first UE may be to transmit a message on the set of resources based on a bit value from the bitmap that may be associated with the first UE.

In some examples of the method, apparatuses, and non-transitory computer-readable medium described herein, determining the set of resources may include operations, features, means, or instructions for identifying that the first UE may be included in a first UE group from a set of two or more UE groups, where a subset of UEs from the set of UEs included in the first UE group may have non-colliding sets of resources, and determining the set of resources based on being included in the first UE group, where communicating with the base station may include operations, features, means, or instructions for transmitting an uplink message to the base station on the set of resources based on the UE being included in the first UE group.

Some examples of the method, apparatuses, and non-transitory computer-readable medium described herein may further include operations, features, means, or instructions for identifying a configuration of a first scrambling sequence for uplink transmissions of the first UE, the first scrambling sequence being different from a second scrambling sequence of a second UE communicating on the set of resources, where communicating with the base station includes transmitting an uplink message on the set of resources including a demodulation reference signal scrambled in accordance with the first scrambling sequence.

Some examples of the method, apparatuses, and non-transitory computer-readable medium described herein may further include operations, features, means, or instructions for determining a hybrid automatic request (HARQ) process identifier based on a time interval associated with receiving a downlink message from the base station using the set of resources, and transmitting a feedback message to the base station based on the HARQ process identifier.

Some examples of the method, apparatuses, and non-transitory computer-readable medium described herein may further include operations, features, means, or instructions for decoding the DCI based on a CRC of the DCI that may be scrambled with a RNTI that may be common across the set of UEs.

In some examples of the method, apparatuses, and non-transitory computer-readable medium described herein, communicating with the base station may include operations, features, means, or instructions for receiving data for the first UE via a PDSCH.

In some examples of the method, apparatuses, and non-transitory computer-readable medium described herein, communicating with the base station may include operations, features, means, or instructions for transmitting data to the base station via a physical uplink shared channel (PUSCH).

A method of wireless communication at a base station is described. The method may include transmitting DCI to a set of UEs, the DCI including unicast scheduling information for the set of UEs and communicating with one or more UEs of the set of UEs using respective sets of resources that are determined based on the unicast scheduling information for the set of UEs.

An apparatus for wireless communication at a base station is described. The apparatus may include a processor, memory coupled with the processor, and instructions stored in the memory. The instructions may be executable by the processor to cause the apparatus to transmit DCI to a set of UEs, the DCI including unicast scheduling information for the set of UEs and communicate with one or more UEs of the set of UEs using respective sets of resources that are determined based on the unicast scheduling information for the set of UEs.

Another apparatus for wireless communication at a base station is described. The apparatus may include means for transmitting DCI to a set of UEs, the DCI including unicast scheduling information for the set of UEs and communicating with one or more UEs of the set of UEs using respective sets of resources that are determined based on the unicast scheduling information for the set of UEs.

A non-transitory computer-readable medium storing code for wireless communication at a base station is described. The code may include instructions executable by a processor to transmit DCI to a set of UEs, the DCI including unicast scheduling information for the set of UEs and communicate with one or more UEs of the set of UEs using respective sets of resources that are determined based on the unicast scheduling information for the set of UEs.

Some examples of the method, apparatuses, and non-transitory computer-readable medium described herein may further include operations, features, means, or instructions for determining a set of resources for communicating with a first UE of the one or more UEs based on one or more predefined rules including a UE-specific transformation of time and frequency resources that may be common across the set of UEs, where the time and frequency resources may be indicated by the DCI.

In some examples of the method, apparatuses, and non-transitory computer-readable medium described herein, the UE-specific transformation includes a shift, a scaling, a modification, or any combination thereof, of the time and frequency resources.

Some examples of the method, apparatuses, and non-transitory computer-readable medium described herein may further include operations, features, means, or instructions for transmitting, to the first UE, a configuration of the one or more predefined rules, and determining the set of resources for communicating with the first UE based on the configuration.

Some examples of the method, apparatuses, and non-transitory computer-readable medium described herein may further include operations, features, means, or instructions for determining the UE-specific transformation based on an identity of the first UE, an index of a table including a set of candidate transformation values, or any combination thereof.

In some examples of the method, apparatuses, and non-transitory computer-readable medium described herein, the UE-specific transformation includes a function that may be constant over time, variable over time, or any combination thereof.

Some examples of the method, apparatuses, and non-transitory computer-readable medium described herein may further include operations, features, means, or instructions for transmitting, to a first UE of the one or more UEs, a message via a PDSCH based on a first set of resources for the first UE, where the message may be scrambled using a scrambling sequence that may be specific to the first UE, and refraining from transmitting to other UEs of the one or more UEs based on a collision between the first set of resources and respective sets of resources for the other UEs.

Some examples of the method, apparatuses, and non-transitory computer-readable medium described herein may further include operations, features, means, or instructions for identifying one or more candidate shifts that may be specific to a first UE of the one or more UEs, and transmitting, to the first UE, a configuration of the one or more candidate shifts, where a set of resources for communicating with the first UE may be based on the one or more candidate shifts.

Some examples of the method, apparatuses, and non-transitory computer-readable medium described herein may further include operations, features, means, or instructions for transmitting, within the DCI, a bitmap indicating whether messages for the set of UEs may be to be transmitted, the bitmap including respective bit values for each UE of the set of UEs, and indicating, to a first UE of the one or more UES, that a message for the first UE may be to be transmitted on a set of resources based on a bit value from the bitmap that may be associated with the first UE.

Some examples of the method, apparatuses, and non-transitory computer-readable medium described herein may further include operations, features, means, or instructions for identifying that a first UE of the one or more UEs may be included in a first UE group from a set of two or more UE groups, where a subset of UEs from the set of UEs included in the first UE group may have non-colliding sets of resources, and determining a set of resources for communicating with the first UE based on the first UE being included in the first UE group.

Some examples of the method, apparatuses, and non-transitory computer-readable medium described herein may further include operations, features, means, or instructions for transmitting the DCI via a PDCCH based on the first UE being included in the first UE group, where the DCI may be transmitted in a first set of one or more time intervals associated with the first UE group, the first set of one or more time intervals being different from a second set of one or more time intervals associated with a second UE group of the set of two or more UE groups.

Some examples of the method, apparatuses, and non-transitory computer-readable medium described herein may further include operations, features, means, or instructions for transmitting, within the DCI, a bitmap indicating that the first UE may be included in the first UE group, the bitmap including respective bit values for UEs associated with each UE group of the set of two or more UE groups, where the respective bit values indicate whether messages for the UEs associated with each UE group may be to be transmitted.

Some examples of the method, apparatuses, and non-transitory computer-readable medium described herein may further include operations, features, means, or instructions for transmitting, to a first UE of the one or more UEs, one or more repetitions of a message based on the DCI and a set of resources associated with the first UE, the DCI scheduling unicast repetitions of the message for the first UE.

Some examples of the method, apparatuses, and non-transitory computer-readable medium described herein may further include operations, features, means, or instructions for transmitting a second DCI to a first UE of the one or more UEs, where the DCI and the second DCI may be associated with scheduling unicast repetitions of a message for the first UE, and transmitting one or more repetitions of the message based on the DCI, the second DCI, and a set of resources associated with the first UE.

Some examples of the method, apparatuses, and non-transitory computer-readable medium described herein may further include operations, features, means, or instructions for determining, based on a decoding failure of a message transmitted on a first set of resources for a first UE of the one or more UEs, a second set of resources for a retransmission of the message, where the second set of resources may be different from the first set of resources.

In some examples of the method, apparatuses, and non-transitory computer-readable medium described herein, the set of resources may be associated with a first scrambling identifier and the second set of resources may be associated with a second scrambling identifier different from the first scrambling identifier, and where the second set of resources may be the same as the set of resources.

In some examples of the method, apparatuses, and non-transitory computer-readable medium described herein, the second set of resources may be different from the set of resources.

Some examples of the method, apparatuses, and non-transitory computer-readable medium described herein may further include operations, features, means, or instructions for transmitting a second DCI that schedules the second set of resources for the retransmission, where the second set of resources may be based on the second DCI.

Some examples of the method, apparatuses, and non-transitory computer-readable medium described herein may further include operations, features, means, or instructions for transmitting the retransmission of the message on the second set of resources, where the message may be identified as the retransmission of the message based on transmitting the message on the second set of resources.

Some examples of the method, apparatuses, and non-transitory computer-readable medium described herein may further include operations, features, means, or instructions for triggering, for each UE of the set of UEs, a switch from a first BWP to a second BWP based on the DCI.

Some examples of the method, apparatuses, and non-transitory computer-readable medium described herein may further include operations, features, means, or instructions for triggering, for a first UE of the set of UEs, a switch from a first BWP to a second BWP based on the DCI, the DCI including a respective BWP identifier field for each UE of the set of UEs, where the switch from the first BWP may be identified based on a first BWP identifier field corresponding to the first UE.

Some examples of the method, apparatuses, and non-transitory computer-readable medium described herein may further include operations, features, means, or instructions for transmitting a second DCI including unicast scheduling information for a first UE of the one or more UEs, the second DCI triggering a switch of the first UE from a first BWP to a second BWP.

Some examples of the method, apparatuses, and non-transitory computer-readable medium described herein may further include operations, features, means, or instructions for transmitting, to a first UE of the one or more UEs, a second DCI including information for a group of UEs from the set of UEs, the second DCI triggering a switch from a first BWP to a second BWP for the group of UEs.

In some examples of the method, apparatuses, and non-transitory computer-readable medium described herein, the DCI may be transmitted within a set of control resources that may be configured across a first BWP and a second BWP.

Some examples of the method, apparatuses, and non-transitory computer-readable medium described herein may further include operations, features, means, or instructions for transmitting, to a subset of UEs from the set of UEs, a second DCI including unicast scheduling information for the set of UEs, the second DCI transmitted within a second set of control resources associated with a second BWP, where the subset of UEs may be switched to the second BWP based on the second set of control resources of the second BWP used for the second DCI.

Some examples of the method, apparatuses, and non-transitory computer-readable medium described herein may further include operations, features, means, or instructions for configuring a TCI state that indicates quasi co-location information, the quasi co-location information being common across a group of UEs from the set of UEs, where the DCI includes a bitmap indicating whether messages for the group of UEs may be to be transmitted, and where communicating with the one or more UEs may be based on the configured TCI state.

Some examples of the method, apparatuses, and non-transitory computer-readable medium described herein may further include operations, features, means, or instructions for transmitting, within the DCI, one or more communications parameters for communicating with the base station, where the one or more communications parameters may be indicated within a same field for each UE of the set of UEs, where UE-specific communications parameters for communicating with respective UEs may be based on at least a portion of a table associated with the one or more communications parameters.

In some examples of the method, apparatuses, and non-transitory computer-readable medium described herein, the one or more communications parameters include a modulation and coding scheme, an antenna port, a virtual resource block to physical resource block mapping, a PUCCH resource, feedback timing, rate matching information, a zero power channel state information reference signal trigger, or any combination thereof.

In some examples of the method, apparatuses, and non-transitory computer-readable medium described herein, the DCI excludes a transmit power control field, or a counter downlink assignment index field, or any combination thereof.

Some examples of the method, apparatuses, and non-transitory computer-readable medium described herein may further include operations, features, means, or instructions for transmitting, within the DCI, a bitmap indicating whether the set of UEs may be to transmit messages on respective sets of resources, the bitmap including respective bit values for each UE of the set of UEs, where communicating with the one or more UEs may be based on the respective bit values.

In some examples of the method, apparatuses, and non-transitory computer-readable medium described herein, determining the set of resources may include operations, features, means, or instructions for identifying that a first UE of the one or more UEs may be included in a first UE group from a set of two or more UE groups, where a subset of UEs from the set of UEs included in the first UE group may have non-colliding sets of resources, and determining a set of resources associated with the first UE for receiving uplink messages based on the first UE being included in the first UE group, where communicating with the one or more UEs may include operations, features, means, or instructions for receiving an uplink message from the first UE on the set of resources.

Some examples of the method, apparatuses, and non-transitory computer-readable medium described herein may further include operations, features, means, or instructions for transmitting, to a first UE of the one or more UEs, a first configuration of a first scrambling sequence for transmissions of the first UE, transmitting, to a second UE of the one or more UEs, a second configuration of a second scrambling sequence for transmissions of the second UE, the second scrambling sequence being different from the first scrambling sequence, and receiving a first uplink message from the first UE and a second uplink message from the second UE on the set of resources, the first uplink message including a first demodulation reference signal scrambled in accordance with the first scrambling sequence, and the second uplink message including a second demodulation reference signal scrambled in accordance with the second scrambling sequence.

Some examples of the method, apparatuses, and non-transitory computer-readable medium described herein may further include operations, features, means, or instructions for receiving, from a first UE of the one or more UEs, a feedback message in accordance with a HARQ process identifier that may be based on a time interval associated with transmitting a downlink message using a set of resources associated with the first UE.

Some examples of the method, apparatuses, and non-transitory computer-readable medium described herein may further include operations, features, means, or instructions for scrambling a CRC of the DCI based using a RNTI that may be common across the set of UEs.

In some examples of the method, apparatuses, and non-transitory computer-readable medium described herein, communicating with the base station may include operations, features, means, or instructions for transmitting data to the one or more UEs via a PDSCH.

In some examples of the method, apparatuses, and non-transitory computer-readable medium described herein, communicating with the base station may include operations, features, means, or instructions for receiving data from the one or more UEs via a PUSCH.

### BRIEF DESCRIPTION OF THE DRAWINGS

FIG. 1 and FIG. 2 illustrate examples of wireless communications systems that support DCI for unicast scheduling of multiple UEs in accordance with aspects of the present disclosure.

FIG. 3A, FIG. 3B, FIG. 4, and FIG. 5 illustrate examples of DCI designs that support DCI for unicast scheduling of multiple UEs in accordance with aspects of the present disclosure.

FIG. 6 illustrates an example of a process flow in a system that supports DCI for unicast scheduling of multiple UEs in accordance with aspects of the present disclosure.

FIGS. 7 and 8 show block diagrams of devices that support DCI for unicast scheduling of multiple UEs in accordance with aspects of the present disclosure.

FIG. 9 shows a block diagram of a communications manager that supports DCI for unicast scheduling of multiple UEs in accordance with aspects of the present disclosure.

FIG. 10 shows a diagram of a system including a device that supports DCI for unicast scheduling of multiple UEs in accordance with aspects of the present disclosure.

FIGS. 11 and 12 show block diagrams of devices that support DCI for unicast scheduling of multiple UEs in accordance with aspects of the present disclosure.

FIG. 13 shows a block diagram of a communications manager that supports DCI for unicast scheduling of multiple UEs in accordance with aspects of the present disclosure.

FIG. 14 shows a diagram of a system including a device that supports DCI for unicast scheduling of multiple UEs in accordance with aspects of the present disclosure.

FIGS. 15 through 20 show flowcharts illustrating methods that support DCI for unicast scheduling of multiple UEs in accordance with aspects of the present disclosure.

### DETAILED DESCRIPTION

Some wireless communication system may support unicast data scheduling for user equipment (UEs) using downlink control information (DCI). In some cases, DCI may inform a UE on how to decode downlink transmissions and which resources to allocate for downlink transmissions. DCI may also include a cyclic redundancy check (CRC) attachment which may aid in error reduction and may be scrambled by a UE-specific radio network temporary identifier (RNTI). A base station may assign each UE within a cell a UE-specific RNTI and the UE may use this RNTI to determine which DCI is meant for the UE. For example, a first UE may be assigned a first UE-specific RNTI and a second UE may be assigned a second UE-specific RNTI. The base station may transmit a DCI that is CRC-scrambled by the first RNTI and a second DCI that is CRC-scrambled by a second RNTI. The first UE may decode the first DCI and identify a first resource allocation for downlink transmissions and the second UE may decode the second DCI and identify a second resource allocation for downlink transmissions. That is, the first UE and the second UE may recognize different DCI and identify different downlink resource allocations based on the respective DCI. However, the UEs may be located within an automated system (e.g., smart building) and may be examples of a reduced capacity UEs. In such case, the UEs may transmit and receive aperiodic data and/or relatively small data (e.g., equal to or less than a minimum transport block (TB) size). Because each UE may receive separate DCI (e.g., UE-specific DCI) for unicast scheduling, signaling overhead (e.g., via physical downlink control channel (PDCCH)) in the system may increase, which may decrease overall system efficiency.

Some wireless communication systems may support a single DCI design that provides unicast scheduling information for multiple UEs. For example, a base station may transmit DCI which may be CRC scrambled by a UE group-common RNTI. Unlike a UE-specific RNTI, a UE group-common RNTI may be recognizable to multiple UEs within a cell. That is, the UEs within a cell may decode DCI CRC scrambled by a group-RNTI. The DCI may include a set of common scheduling parameters, such as time and frequency domain resources allocation, and the like. The scheduled UEs within the cell may decode the DCI and determine resources for downlink and uplink transmissions from the resource allocation included in the DCI using a UE-specific transformation rule. The UE-specific transformation rule may be configured by the network to each UE, or the transformation rule may be function of a UE's identity, or any combination thereof. By using a singular DCI for unicast scheduling of multiple UEs, overhead signaling on the PDCCH may be decreased in situations of high automation.

In some cases, UEs may experience resource collisions using the DCI design for unicast scheduling for multiple UEs. For example, resource collisions may occur if a number of UEs exceeds an amount of available resources, and different UEs may select the same or similar resources (e.g., based on their own UE-specific transformation applied to the common scheduling parameters). In some examples, however, the base station may identify possible collisions between UEs and may choose to transmit downlink transmissions associated with only one of the colliding UEs. In addition, the network may mitigate resource collision by assigning different candidate shifts to the UEs. Additionally or alternatively, a bitmap may be included in the DCI, where each bit indicates, for example, whether a physical downlink shared channel (PDSCH) for a UE is transmitted, and colliding UEs may not be assigned the bit associated with a transmitted PDSCH. Additionally or alternatively, the network may split the UEs into different groups such that colliding UEs may not be included in the same group. In other examples, different UEs may select the same resources, but may differentiate their uplink transmissions to the base station on the same resources (e.g., using different scrambling sequences).

Aspects of the disclosure are initially described in the context of wireless communications systems. Additional aspects are described in the context of DCI designs and process flows. Aspects of the disclosure are further illustrated by and described with reference to apparatus diagrams, system diagrams, and flowcharts that relate to DCI for unicast scheduling of multiple UEs.

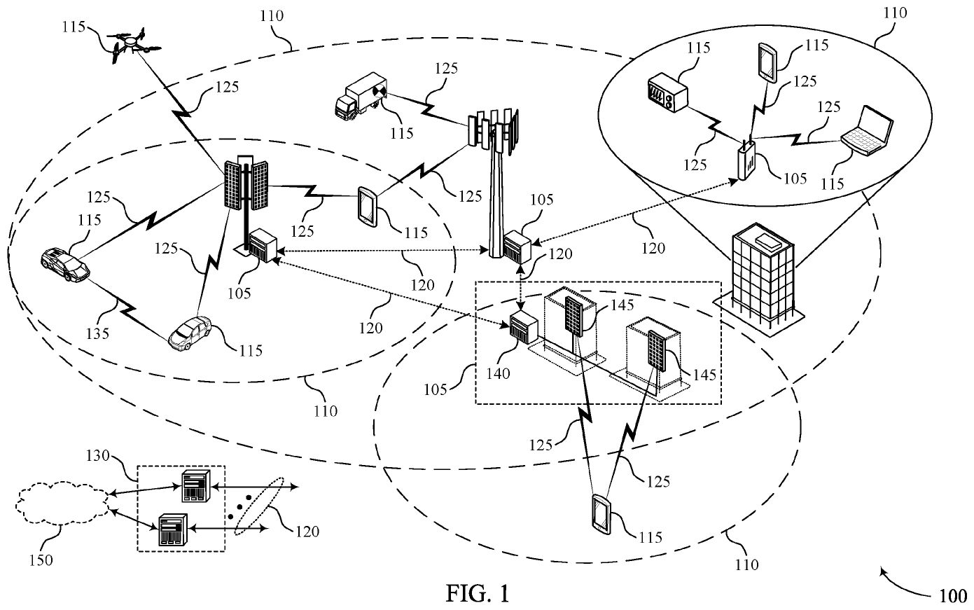

FIG. 1 illustrates an example of a wireless communications system 100 that supports DCI for unicast scheduling of multiple UEs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology. Components within a wireless communication system may be coupled (for example, operatively, communicatively, functionally, electronically, and/or electrically) to each other.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. A UE 115 may be a device such as a cellular phone, a smart phone, a multimedia/entertainment device (e.g., a radio, a MP3 player, a video device, etc.), a camera, a gaming device, a navigation/positioning device (e.g., global navigation satellite system (GNSS) devices based on, for example, global positioning system (GPS), BeiDou, GLONASS, or Galileo, a terrestrial-based device, etc.), a netbook, a smartbook, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as category (CAT)-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. In some examples, a UE 115 may be referred to as a reduced-capacity UE, a low-complexity UE, or a super-light UE (or super-light capability UE), or other like terminology.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., CRC), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a base station may use a single DCI design for scheduling multiple UEs for unicast transmissions. For example, a base station may scramble a CRC attachment of the DCI with a UE group-common RNTI and transmit the DCI to a group of UEs, where the DCI may include a set of unicast scheduling parameters. The UEs may decode the DCI and determine a set of resources from the unicast scheduling parameters using a transformation rule and communicate with the base station on the determined set of resources.

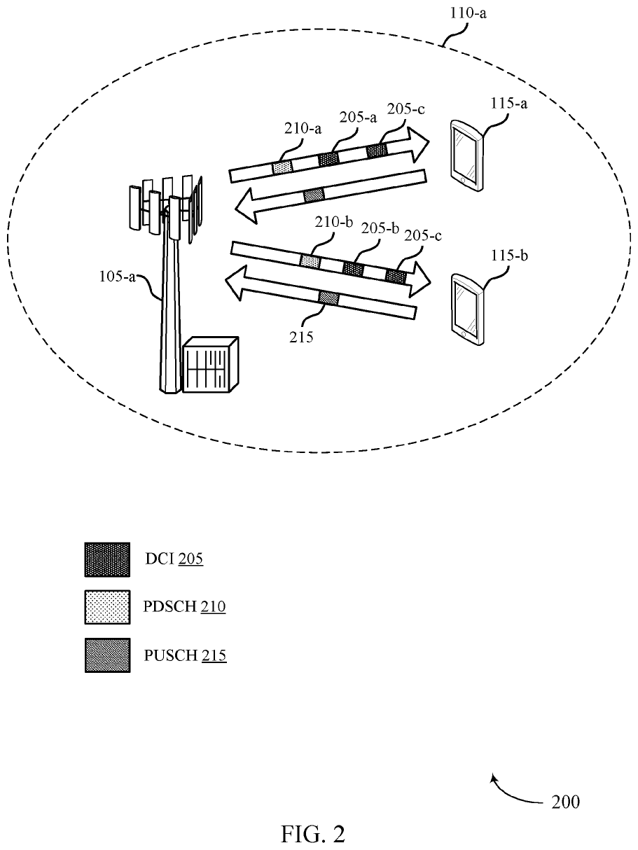

FIG. 2 illustrates an example of a wireless communications system 200 that supports DCI for unicast scheduling of multiple UEs in accordance with aspects of the present disclosure. In some examples, wireless communications system 200 may implement aspects of wireless communications system 100. The wireless communications system 200 may include base station 105-a, UE 115-a, and UE 115-b which may be examples of a base station 105 and UEs 115 as described with reference to FIG. 1. Base station 105-a, UE 115-a, and UE 115-b may be located within coverage area 110-a.

In some examples, a base station 105 may schedule UEs 115 for unicast downlink transmissions. For example, base station 105-a may transmit DCI 205 to UE 115-a and UE 115-b. DCI 205 may inform UEs 115 of how to decode downlink transmissions from base station 105-a as well as which resources to allocate for downlink transmissions from base station 105-a. DCI 205 may be received on a physical downlink control channel (PDCCH) and downlink data transmissions may be received on a PDSCH 210 (e.g., PDSCH 210-a or PDSCH 210-b). In some examples, DCI 205 may include a CRC attachment which may aid in error detection. The CRC attachment may be scrambled with a UE-specific radio network temporary identifier (RNTI), where the RNTI may acts as an identification of a particular UE 115. The base station 105 may assign each UE 115 within coverage area 110-a with a UE-specific RNTI and a UE 115 may use the RNTI to identify whether a DCI 205 is meant for it. For example, base station 105-a may assign UE 115-a with a first UE-specific RNTI and may assign UE 115-b with a second UE-specific RNTI. Base station 105-a may transmit DCI 205-a which may be CRC scrambled by a first UE-specific RNTI and DCI 205-b which may be CRC scrambled by a second UE-specific RNTI. UE 115-a may decode DCI 205-a and identify resources for downlink transmissions based on the information within DCI 205-a. Alternatively, UE 115-b may decode DCI 205-b and identify resource for downlink transmissions based on the information within DCI 205-b. That is, UE 115-a and UE 115-b may identify different PDSCH resources on which to receive downlink transmissions from base station 105-a based on two different DCI.

In some examples, UEs 115 may encounter situations in which PDCCH overhead is large. For example, UEs 115 may be examples of reduced capacity UEs operating within a smart building or other relatively highly automated space. Reduced capacity UEs may receive and transmit relatively small pieces of data (e.g., small transport block size) and the data may be not be scheduled based on semi-persistent scheduling (SPS) (e.g., periodic scheduling). As a result, the PDCCH overhead may be large and the efficiency of the wireless communications system may decrease. The methods and apparatuses disclosed herein provide for a single DCI that supports scheduling of unicast transmissions for multiple UEs 115, which may accordingly decrease signaling overhead.

As an example, wireless communications system 200 may support a DCI design for unicast scheduling for multiple UEs 115. Base station 105-a may transmit DCI 205-c to UE 115-a and UE 115-b. DCI 205-c may be CRC scrambled by a UE group-common RNTI. Unlike a UE-specific RNTI, a UE group-common RNTI may not correspond to a singular UE 115 within coverage area 110-a, but rather to multiple UEs 115 within coverage area 110-a. That is, both UEs 115-a and UE 115-b may recognize and decode DCI 205-c. DCI 205-c may include a set of common scheduling parameters, such as a time and frequency domain resource allocation, etc., and UE 115-a and UE 115-b may determine their own time and frequency resources from the resource allocation based on a UE-specific transformation rule. As such, the scheduled UEs 115 within coverage area 110-a may use DCI 205-c, effectively reducing overall PDCCH overhead signaling. In such cases, UE 115-a may use DCI 205-c to identify a first set of resources for receiving PDSCH 210-a and UE 115-a may also use DCI 205-c to identify a second, different set of resources for receiving PDSCH 210-b.

In some examples, the UE-specific transformation rule (which may be predefined) may include shifting, scaling, or modifying, or any combination thereof, the time and frequency domain resource allocation provided by DCI 205-c. The predefined transformation rule may be configured to each UE 115 by base station 105. Additionally or alternatively, the transformation rule may be determined as a function of an identity of a UEs 115 (e.g., UE-ID or cell-RNTI (C-RNTI)).

In some examples, devices within wireless communications system 200 may experience resource collision when using DCI 205-c. Resource collision may occur, for example, if a number of UEs 115 within coverage area 110-a is larger than number of resources. In such cases, UEs 115 may determine the same resources or overlapping resources if the amount of UEs 115 overwhelm the time and frequency domain resource allocation included within DCI 205-c. In some examples, a base station 105 may have knowledge of resource collisions between UEs 115. For example, base station 105-a may determine that a collision may occur between UE 115-a and UE 115-b. In such example, base station 105-a may only transmit downlink data associated with either UE 115-a or UE 115-b to avoid the collision. The UE 115 whose downlink transmission is not sent may fail to decode the downlink transmission and may transmit a negative acknowledgment (NACK) feedback to the network. Additionally or alternatively, if base station 105-a determines a collision between UE 115-a and UE 115-b, the network may define multiple candidate shifts for UE 115-a and UE 115-b. Additionally or alternatively, base station 105-a may determine which UEs 115 may be prioritized over other UEs 115, such as when resource collisions may occur. For example, base station 105-a may utilize a bitmap in DCI 205-c. The bitmap may indicate which UEs 115 will receive a downlink transmission and which will not. For example, if base station 105-a determines that resources selected by UE 115-a and UE 115-b may collide (e.g., based on the transformation rules used by each UE 115), the bitmap included with DCI 205-c may indicate that UE 115-a is scheduled to receive a downlink transmission and that UE 115-b is not scheduled to receive data. Additionally or alternatively, the network may split the UEs 115 into different groups, where colliding UEs 115 are included in different groups, and each group may be assigned different slots for PDCCH monitoring.

In some examples, DCI 205 may indicate information regarding HARQ processes for each UE 115. In order to keep track of each HARQ process, the base station 105 and UE 115 may know a HARQ process ID for each transmission and reception of the HARQ data which may be provided in DCI 205. Because DCI 205-c may apply to multiple UEs 115 in coverage area 110-a (e.g., providing unicast scheduling information for the multiple UEs 115), DCI 205-c may not support different HARQ processes for different UEs 115. As a result, UEs 115 may support a singular HARQ process (e.g., singular HARQ process ID) or UEs 115 may determine the HARQ process ID based on a slot number where the downlink transmission starts.

In some example, UE 115 may not receive or accurately decode downlink transmissions from the base station 105 and receive a retransmission from base station 105. For example, UE 115-a may not successfully decode a downlink transmission from base station 105-a and transmit a NACK message to base station 105-a. In the case where multiple HARQ processes are supported by UEs 115, base station 105-a may transmit DCI 205-a (e.g., DCI scrambled by UE-specific RNTI) to UE 115-a indicating resources to receive the retransmission. Alternatively, in the case where a single HARQ process is supported by UEs 115, base station 105-a may transmit DCI 205-c (e.g., DCI scrambled by UE group-common RNTI) to UE 115-a and UE 115-a may determine two hypothetical blocks of time and frequency resources, where each block may be based on a UE-specific transformation of scheduling information included in DCI 205-c.

In some examples, UE 115-a and UE 115-b may receive a different number repetitions of a downlink transmission. For example, UE 115-a may be scheduled for a first number of repetitions and UE 115-b may be scheduled for a second number of repetitions different from the first number. UE 115-a may receive DCI 205-c for the first repetition and ignore future DCIs 205 associated with subsequent repetitions until the entire sequence of repetitions is over. Additionally or alternatively, the network may provide separate DCIs (e.g., DCI 205-a) with meaningful scheduling information for all repetitions of the same transmission. That is, UE 115-a may still receive and decode additional DCIs transmitted by base station 105-a for respective repetitions of a transmission, which may ensure that UE 115-a monitors for (and detects) DCI 205-c that includes unicast scheduling information for multiple UEs 115.

In some examples, UEs 115 may undergo a bandwidth part (BWP) switch. In some examples, the network may trigger the UE 115 to switch its uplink or downlink BWP using a field within DCI 205 (e.g., BWP ID field). In the case of using DCI 205-c, a BWP switch for each UE 115 of all scheduled UEs 115 may switch to their respective BWP with the same BWP ID if a BWP switch is triggered. In other examples, one or more additional BWP ID fields may be included in DCI 205-c, with different fields for each UE 115. Additionally or alternatively, DCI 205-a or DCI 205-b may be used for BWP switching. That is, if UE 115-a were to undergo a BWP switch, UE 115-a may receive DCI 205-a (e.g., DCI scrambled by UE-specific RNTI) indicating the BWP to switch to. Additionally or alternatively, a separate DCI 205 may be supported for BWP switching for the scheduled UEs. An example of a BWP switch DCI may be a wake-up signal (WUS)-based dormancy switch DCI. In some examples, a UE may monitor PDCCH in a dormant (or inactive) BWP if the DCI 205-c is applied to a primary cell (e.g., a PCell).

In some aspects, DCI 205-c may be BWP dependent or not. In the case that DCI 205-c is not BWP dependent, a same control resource to both BWPs may be in overlapping RBs before and after the BWP switch, and base station 105-a may send DCI 205-c on the overlapping control resources. Alternatively, in the case that DCI 205-c is BWP dependent, DCI 205-c may be transmitted on resources that are specific to respective BWPs. Here, base station 105-a may configure one or more UEs 115 in a source BWP to make use of a released bit in the bitmap described herein and the time/frequency resources associated with the associated UEs, which may be based on releasing other UEs 115 undergoing a BWP switch from the source BWP.

In some examples, transmission configuration indicator (TCI) states may be dynamically indicated via DCI 205, which may include relationships such as quasi co-location (QCL) relationships. DCI 205-c may indicate to multiple UEs 115 the QCL relationships by the same TCI field value. The same TCI field value may indicate different QCL relationships for different UEs 115. Because the UE 115-a and UE 115-b may exhibit low mobility, they may be able to utilize consistent QCL relationships for communicating with base station 105-a.

DCI 205-c may also indicate other scheduling information (e.g., modulation and coding schemes (MCS), antenna ports, virtual resource block (VRB)-to-physical resource block (PRB) mapping, physical uplink control channel (PUCCH) resources, PDSCH-to-HARQ feedback timing, rate matching, zero power (ZP) CSI-RS triggers) for each UE 115 of the multiple UEs 115. The scheduling information may use the same field within DCI 205-c for the multiple UEs 115. In some examples, UEs 115 may interpret the field differently. For example, the network may configure each UE 115 with an indexed table containing the scheduling information and may reconfigure the table if channel conditions change. Additionally, DCI 205-c may exclude a transmit power control (TPC) field, and UEs 115 may rely on group TPC DCI. In some examples, DCI 205-c may exclude a downlink assignment index (DAI) counter field.

In some examples, DCI 205-c may be used to allocate resources for uplink transmissions on a physical uplink shared channel (PUSCH) 215. In such cases DCI 205-c may include scheduling information for multiple UEs 115, and base station 105-a may mitigate or reduce collisions of uplink transmissions based on a bitmap or grouping of UEs indicated by the DCI 205-c (e.g., as described herein). Additionally, the network may configure different demodulation reference signal (DMRS) scrambling to colliding PUSCHs of different UEs 115. In this way, different UEs 115 may select a same or similar resources for transmission of PUSCH 215 (e.g., based on the unicast scheduling information for multiple UEs), but the respective signaling may be differentiated for each UE 115 by using different, UE-specific scrambling sequences (e.g., for DMRS) configured for each UE 115. Thus, while some aspects of the present disclosure may be described in terms of downlink transmissions, it is understood that one or more techniques of the present disclosure may be similarly utilized with uplink transmissions from a UE 115. As an example, UE 115-a may receive a DCI 205-c that includes unicast scheduling information for multiple UEs 115, and UE 115-a may determine a set of uplink resources from the DCI 205-c (e.g., using one or more transformation rules) and transmit PUSCH 215 to the base station using the set of resources.

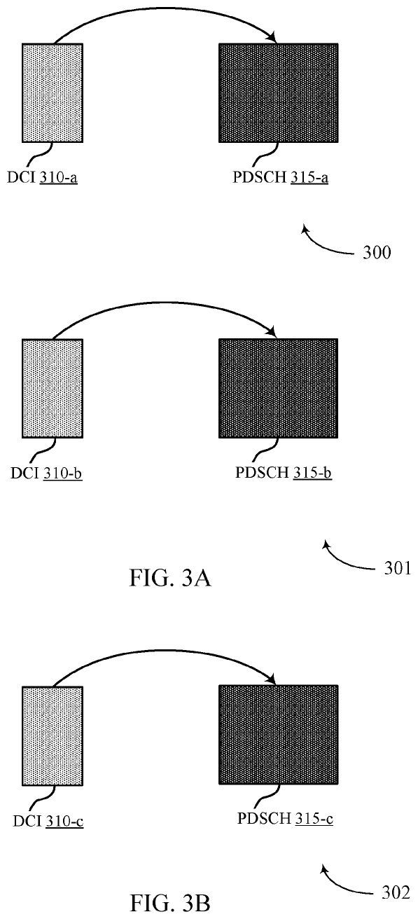

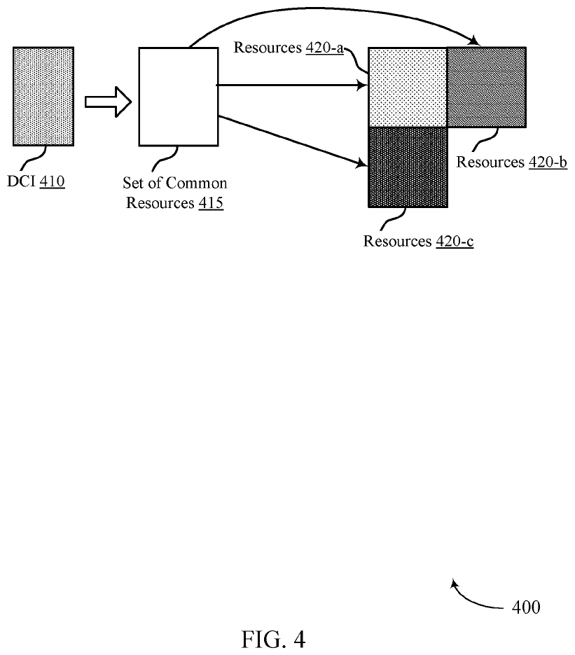

FIGS. 3A and 3B illustrates examples of DCI designs 300, 301, and 302 that supports downlink control information for unicast scheduling of multiple UEs in accordance with aspects of the present disclosure. In some examples, DCI designs 300 301, and 302 may implement aspects of wireless communications system 100 and wireless communications system 200.

As described with reference to FIG. 2, a base station may configure each UE within a cell with an RNTI and transmit DCI CRC scrambled by a UE-specific RNTI (e.g., C-RNTI, CS-RNTI, or MSC-RNTI). The UEs may receive the DCI and determine resources on which to receive unicast downlink transmission from a base station based on the information included within the DCI. For example, the base station may configure a first UE with a first UE-specific RNTI and a second UE with a second UE-specific RNTI. In some examples, the first UE and the second UE are scheduled UEs and as such, the base station may transmit DCI 310-a which may be CRC scrambled according to a first RNTI and DCI 310-b which may be scrambled according to a second RNTI. The first UE may recognize and decode DCI 310-a and reserve resources within PDSCH 315-a whereas the second UE may recognize and decode DCI 310-b and reserve resources within PDSCH 315-b.

In some examples, the first UE and the second UE may be examples of reduced capacity UEs. Reduced capacity UEs may transmit and receive small amounts of data and in some examples, may not support SPS. In such case, PDCCH overhead signaling may increase because each UE may utilize a different DCIs 310 to allocate resources for short and frequent unicast downlink transmissions.

In some examples, DCI 310 may be CRC scrambled by a UE group-common RNTI. Unlike UE-specific RNTIs, UE group-common RNTIs are associated with multiple UEs in a cell. That is, UEs within a cell (e.g., a first UE, a second UE, and a third UE) may be configured with the same UE group-common RNTI and recognize DCI CRC scrambled by a UE group-common RNTI. In some examples, a UE group-common RNTI may be used for broadcast of system information or reception of paging. For example, a base station may transmit DCI 310-c which may be CRC scrambled according to a group-RNTI (e.g., SI-RNTI and P-RNTI) to a first UE, a second UE, and a third UE. The first UE, second UE, and third UE may all recognize and decode DCI 310-c and identify resources on which to receive paging or broadcast of system information. That is, the first UE, the second UE, and the third UE may identify the same resources within PDSCH 315-c for which to receive system information or paging.

In some wireless communications system, DCI 310 which is CRC scrambled by a group-RNTI may be used to schedule unicast downlink transmissions. For example, a base station may transmit DCI 310-c which may be CRC scrambled according to a UE group-common RNTI to a first UE, a second UE, and a third UE. The UE group-common RNTI may be an RNTI specified for unicast transmissions or an updated SI-RNTI, P-RNTI, or any other UE group-common RNTI. DCI 310-c may include a set of common scheduling parameters (e.g., common resource allocation). Unlike paging or system information scheduling, a common resource allocation (e.g., PDSCH 315-c) may not work for unicast scheduling because the risk of resource collision is high. As a result, the first UE, the second UE, and the third UE may determine their own resources from the set of common scheduling parameters on which to receive downlink transmission based on a UE-specific transformation rule. That is, the first UE, the second UE, and the third UE may determine different resources using a single DCI design (e.g., DCI 310-c), decreasing PDCCH overhead signaling.

Further, through the use of DCI 310-c that includes unicast scheduling information for multiple UEs, one or more advantages may be realized. In particular, a single DCI 310-c may be transmitted to multiple UEs that enables each UE of the multiple UEs to receive and/or transmit UE-specific data via a unicast transmission. This may result in increased data rates, increased system capacity, and improved spectral efficiency, to name a few advantages. Additionally, the DCI 310-c may be utilized in systems including a relatively high number of UEs that each transmit/receive relatively small amounts of data, which may provide efficient techniques for each UE to communicate UE-specific information with the network.

FIG. 4 illustrates an example of a DCI design 400 that supports DCI for unicast scheduling of multiple UEs in accordance with aspects of the present disclosure. In some examples, DCI design 400 may implement aspects of wireless communications system 100, wireless communications system 200, DCI design 300, DCI design 301, and DCI design 302.

Some wireless communications systems may support a DCI design scheduling multiple UEs for unicast downlink transmission from a base station. For example, a base station may transmit DCI 410 to the UEs (e.g., a first UE, a second UE, and a third UE) within a cell. DCI 410 may be CRC scrambled by a UE group-common RNTI and as such, the first UE, the second UE, and the third UE may recognize and decode DCI 410. DCI 410 may indicate a set of common resources 415 (e.g., time and frequency domain resource allocation). The UEs may select resources from the indicated common set of resources 410 to receive a downlink transmission using a UE-specific transformation rule. That is, each UE may determine a different set of resources, which may be used for uplink and downlink unicast transmission scheduled by DCI 410. For example, the first UE may determine resources 420-a, the second UE may determine resources 420-b, and the third UE may determine resources 420-c. The resources 420-a, 420-b, and 420-c may each include different sets of resources for communicating with a network based on the respective transformation rules applied by each UE.

The UE-specific transformation rule may allow the UE to determine resources by shifting and/or scaling or otherwise modifying the indicated set of common resources 415. In some examples, the base station may configure each UE with the UE-specific transformation rule. In other examples, the transformation rule may be a function of the UE's identity (e.g., UE-ID, C-RNTI). In such example, the UE may calculate the shifting and/or scaling directly, or the UE may calculate an index (e.g., based on the UE-ID or C-RNTI) and use that index in conjunction with a table containing shifting or/and scaling values. The table may be configured by the network. In some examples, the shifting and/or scaling (e.g., transformation rule) may be constant or dynamic (e.g., varying in time). In the case of dynamic shifting or scaling, the UE may utilize a hash function. Using the hash function may allow the UE to randomize the shift and/or scaling from slot to slot. An example of a function that may be used is shown in Equation 1:

Yₙ=(A·Yₙ₋₁)modD (1)

where Yₙ₋₁ represent the C-RNTI or UE-ID, A represents a constant and D represents an integer. The computed Yₙ is used as input to the transformation rule so that the determined time and frequency resource varies in time.

In some example, resource collision may occur when using DCI CRC scrambled by a UE group-common RNTI for scheduling of unicast downlink transmission. Resource collision may occur when the number of scheduled UEs overwhelm the indicated set of common resources 415. When the number of UEs is larger than the number of resources, a UE may determine the same resources as another UE or the resources of UEs may at least partially overlap. For example, resources 420-a may be allocated to a first UE, resources 420-b may be allocated to a second UE, and resources 420-c may be allocated to a third UE. If those resources constitute the full indicated set of common resources 415, a fourth UE may determine the same resources as the first, second, or third UE (e.g., resources 420-a, resources 420-b, or resources 420-c). In other examples, the fourth UE may determine resources which overlap or partially overlap one or more of the resources determined by the first, second, or third UE. In some examples, the base station may have knowledge of potential resource collisions. In such example, the base station may only transmit data associated with one of the colliding UEs. For example, if the fourth UE determines resources 420-a, the base station may only send a data transmission meant for either the first UE or the fourth UE, but not both. The fourth UE and the first UE may use UE-specific PDSCH scrambling to determine whether the scheduled data transmission is for them or not. The UE that does not have its scheduled data transmitted (e.g., either the first UE or the fourth UE) will fail to decode the data transmission and transmit a NACK to the network. An example of the PDSCH scrambling sequence is shown by Equation 2:

cᵢₙᵢₜ=n_{RNTI}·2¹⁵+q·2¹⁴+n_{ID} (2)

where n_{RNTI} represents the UE-specific RNTI, q represents the codeword number, and n_{ID} represents a scrambling identity number.

In some wireless communications system, resource collision may be mitigated using one or more techniques. One technique to reduce the probability of collisions between UEs may include defining multiple candidate transformations (e.g., shifts/scaling) for resources associated with each UE. The network may assign different candidate transformations to each UE and the UE may transmit bundled ACK/NACK for the decoding results of these candidates.

Another technique for mitigating resources collision may be including a bitmap in DCI 410. For example, each bit (e.g., 0 or 1) in the bitmap may correspond to a UE. Bit 1 may indicate that a data transmission is scheduled for the UE and Bit 0 may indicate that a data transmission is not scheduled for the UE. Because the base station has knowledge of which UEs may potentially collide, colliding UEs may not be configured with bit 1 simultaneously. For example, if the base station determines a first UE and a fourth UE will collide, the base station may assign either the first UE or the fourth UE with bit 1. The base station may determine which UE (e.g., either the first UE or the fourth UE) is assigned bit 1 based on the priority of the data transmission. Another technique for mitigating resource collision may include splitting the UEs within a cell into different groups, where the colliding UEs may not be in the same group. For example, if the base station determines a first UE and a fourth UE collide, the first UE may be assigned to a first group and the fourth UE may be assigned to a second group different from the first group. UEs in each group (e.g., the first group and the second group) may monitor for PDCCH in different slots, for example, based on each UE's search space configuration. Additionally, a bit map may be included in DCI 410 where each bit may indicate whether the UEs in the group are scheduled for downlink transmissions. The techniques mentioned above may help mitigate resources collision and reduce false NACK reporting when using a DCI design for unicast scheduling of multiple UEs.

FIG. 5 illustrates an example of a DCI design 500 that supports DCI for unicast scheduling of multiple UEs in accordance with aspects of the present disclosure. In some examples, DCI design 500 may implement aspects of wireless communications system 100, wireless communications system 200, DCI design 300, DCI design 301, DCI design 302, and DCI design 400.

Some wireless communications systems may support a DCI design scheduling multiple UEs for unicast downlink transmission from a base station and uplink transmissions to the base station. For example, a base station may transmit DCI 510 to UEs within a cell. DCI 510 may be CRC scrambled by a UE group-common RNTI and, as such, multiple UEs within the cell may recognize and decode DCI 510. DCI 510 may indicate a set of common resources 515 (e.g., time and frequency domain resource allocation). UEs may then select resources from the indicated set of common resources 515 to receive a downlink transmission using one or more transformation rules, such as a UE-specific transformation rule. For example, a first UE may determine resources 520-a to receive a new downlink transmission.

In some examples, DCI 510 may support HARQ related processes. As described with reference to FIG. 2, DCI 510 may include a field indicating the HARQ process ID. In frequency division duplex (FDD) systems, eight HARQ processes may be used in any order. However, the UE may not know about HARQ processes information before receiving a downlink transmission and as such, the network transmits this information (e.g., HARQ process ID) in DCI. Because DCI 510 may not be UE-specific and may apply to multiple UEs of the cell, DCI 510 may have a singular HARQ process ID field and may not indicate multiple HARQ process IDs to the UEs of the cell simultaneously. As a result, a single HARQ process may be supported by multiple UEs that may be scheduled by DCI 510. That is, a single HARQ process ID may apply to multiple UEs. Alternatively, the UE may determine a HARQ process ID using transmission time information (e.g., subframe number (SFN), slot number, etc.). An example of an equation for determining the HARQ process ID at the UE is provided by Equation 3:

$$HARQ Process ID = \qquad ( 3 )$$

$$[ floor ( {CURRENT}_{slot} \times \frac{10}{( numberOfSlots PerFrame \times periodicity )} ) ] modulo no . of HARQprocesses$$

In some examples, a UE may not receive a downlink transmission or fail to decode a downlink transmission from the base station. In such example, the UE may transmit a NACK to the base station and the base station may retransmit the failed transmission. In order to allocate resources for the retransmission, the base station may transmit DCI CRC scrambled by a UE-specific RNTI (e.g., C-RNTI) which may contain downlink resources to receive the retransmission. That is, the base station may schedule the single UE for the retransmission using a UE-specific DCI. Alternatively, the UE may use DCI 510 (e.g., DCI scrambled by UE group-common RNTI) to allocate resources for the retransmission. For example, if a single HARQ process is supported by multiple UEs in the cell, the UE and the network may use hypothetical decoding of the PDSCH. For example, the base station may transmit DCI 510 to the UE. DCI 510 may be CRC scrambled by a UE group-common RNTI and may indicate a set of common resources 515. The UE may decode DCI 510 and determine hypothetical resources for the new transmission and the retransmission from the indicated set of common resources 515. For example, the UE may determine resources 520-a for the new transmission and resources 520-b for the retransmission. The UE may determine the resources using the techniques described in FIG. 4. In some examples, the base station may determine two PDSCH transmission hypotheses for the new transmission and the retransmission based on the two PDSCH scrambling IDs, where a UE may use the same resources 520 for the new transmission and the retransmission. In other examples, the two blocks of time and frequency resources (e.g., resources 520-a and resources 520-b) may be used for the new transmission and the retransmission. Depending on which hypothesis is decoded, the UE may determine whether the hypothesis is a new transmission or retransmission. In some examples, the UE may also use DCI 510 if multiple HARQ processes are supported at the UE to allocate resources for retransmission. However, the UE may wait to receive the retransmission until the next occasion for the same HARQ process. In some examples, the UE may perform hypothetical soft combining of the failed transmission and the hypothetical retransmission, for example, as an alternative to the hypothetical decoding.

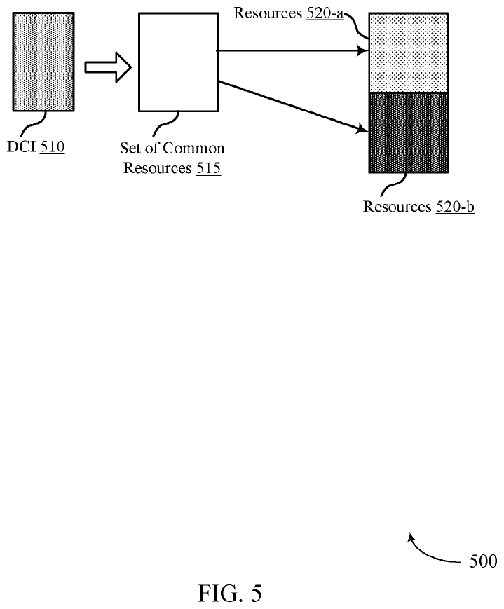

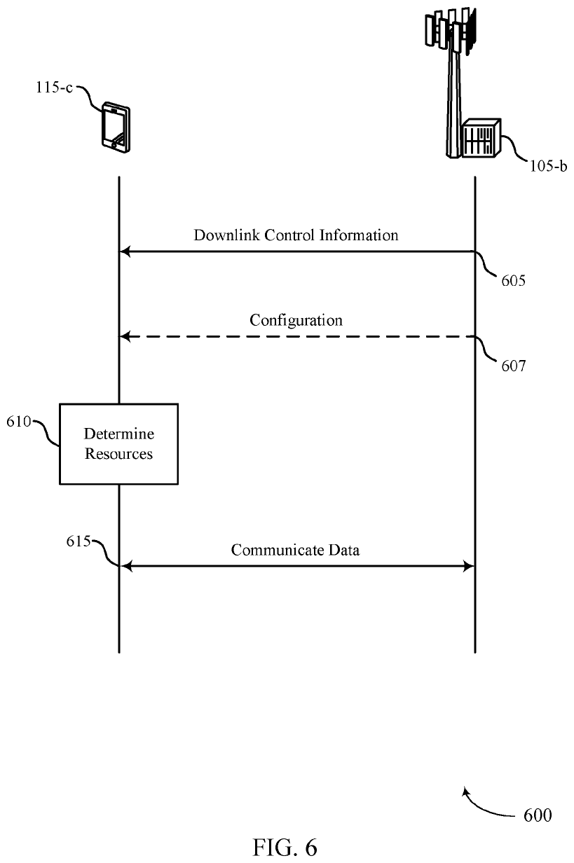

FIG. 6 illustrates an example of a process flow 600 that supports DCI for unicast scheduling of multiple UEs in accordance with aspects of the present disclosure. In some examples, process flow 600 may implement aspects of wireless communications system 100, wireless communications system 200, DCI design 300, DCI design 301, DCI design 302, DCI design 400, and DCI design 500. For example, the process flow 600 may include UE 115-c and base station 105-b, which may be examples of a base station 105 and a UE 115 as described with reference to FIGS. 2 through 5. In some examples, base station 105-b may transmit DCI which is CRC scrambled by a UE group-common RNTI to UE 115-c. The DCI may include unicast scheduling information and UE 115-c may determine a set of resources for communication with base station 105-b from the unicast scheduling information using a UE-specific transformation rule. Base station 105-b and UE 115-c may implement one or more techniques described herein. Alternative examples of the following may be implemented, where steps are performed in a different order than described or are not performed at all. In some cases, steps may include additional features not mentioned below, or further steps may be added.

At 605, base station 105-b may transmit, and UE 115-c may receive DCI. In some cases, the DCI may include a CRC attachment which may be scrambled by a UE group-common RNTI and the DCI may also include common unicast scheduling information such as time and frequency domain resource allocation, etc. The UE group-common RNTI may be recognizable to UE 115-c as well as other UEs located within a cell. The UE 115-c may recognize the UE group-common RNTI, decode the DCI and identify the common unicast scheduling information.

At 607, base station 105-b may transmit, and UE 115-c may receive, a configuration of the one or more predefined rules. At 610, UE 115-c may determine a set of resources for communication with base station 105-b. In some examples, UE 115-c may determine the set of resources by applying a UE-specific transformation rule to the common unicast scheduling information, where the transformation rule may involve shifting or scaling the resources identified as part of the common unicast scheduling information. The transformation rule may be configured to UE 115-c by the network (e.g., based on the configuration at 607), or UE 115-c may determine the transformation rule as a function of UE identify (e.g., C-RNTI or UE-ID). In some examples, UE 115-c may use the DCI to determine resources for downlink transmissions only or for both uplink and downlink transmissions.

At 615, UE 115-c and base station 105-b may communicate data on the set of resources determined at step 510. As stated above, the communication may include uplink or downlink transmissions.

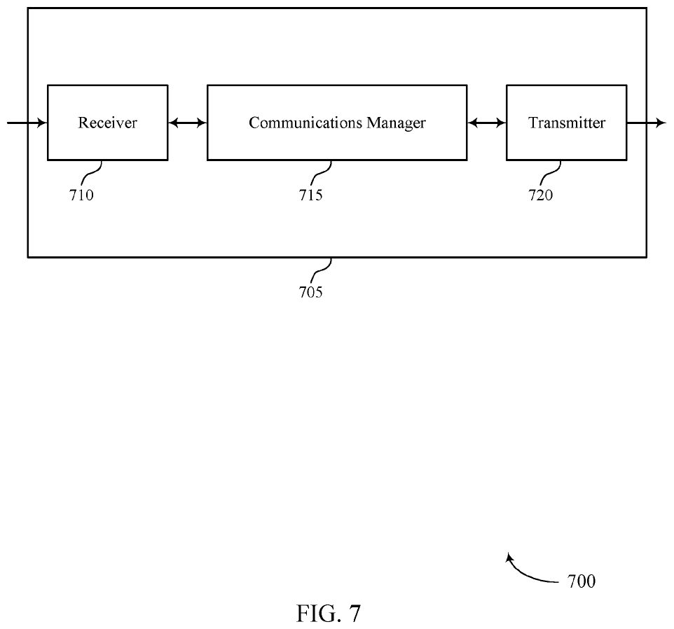

FIG. 7 shows a block diagram 700 of a device 705 that supports DCI for unicast scheduling of multiple UEs in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

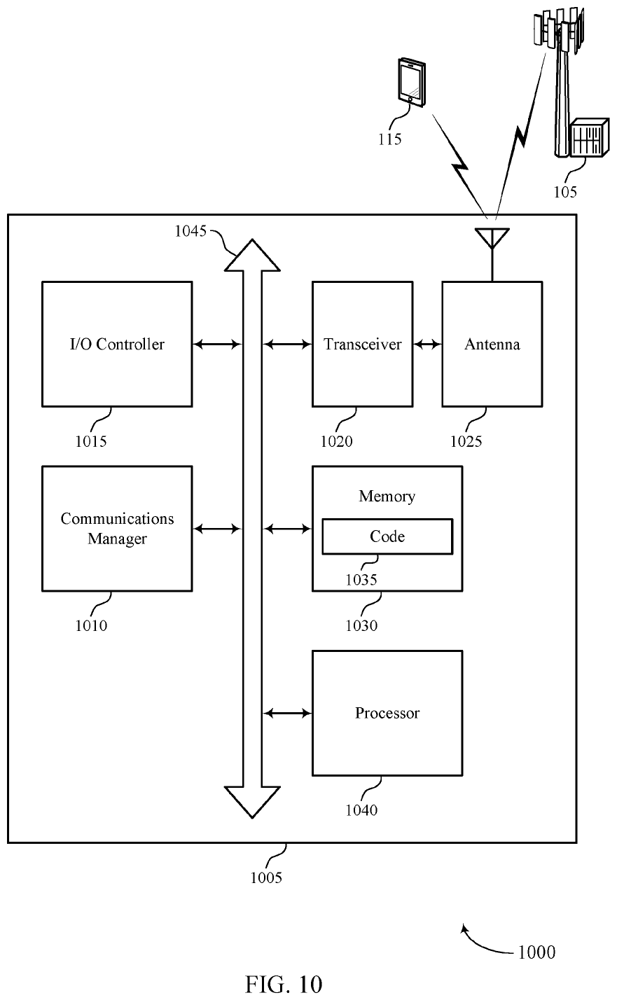

The receiver 710 may receive information such as packets, user data, or control information associated with various information channels (e.g., control channels, data channels, and information related to DCI for unicast scheduling of multiple UEs, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may receive DCI from a base station, the DCI including unicast scheduling information for a set of UEs including the first UE, determine, from the unicast scheduling information, a set of resources for communicating with the base station, and communicate with the base station using the set of resources based on the determination. The communications manager 715 may be an example of aspects of the communications manager 1010 described herein.

The actions performed by the communications manager 715 as described herein may be implemented to realize one or more potential advantages. For example, utilizing a single DCI for scheduling of unicast transmissions may allow device 705 and the system to utilize more control channel resources. A single DCI may occupy less resources than multiple DCIs. As such, more resources are available for control signaling and overall system efficiency may increase. Additionally, the incorporation of collision mitigation techniques (e.g., bitmap or grouping of UEs) may lower the possibility of resource collision and the reporting of false NACK feedback at device 705.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

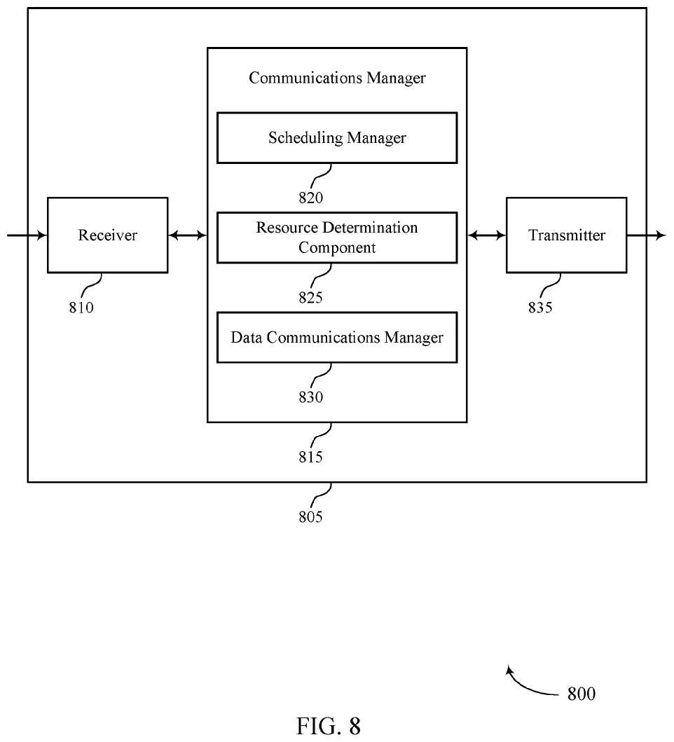

FIG. 8 shows a block diagram 800 of a device 805 that supports DCI for unicast scheduling of multiple UEs in accordance with aspects of the present disclosure. The device 805 may be an example of aspects of a device 705, or a UE 115 as described herein. The device 805 may include a receiver 810, a communications manager 815, and a transmitter 835. The device 805 may also include a processor. Each of these components may be in communication with one another (e.g., via one or more buses).

The receiver 810 may receive information such as packets, user data, or control information associated with various information channels (e.g., control channels, data channels, and information related to DCI for unicast scheduling of multiple UEs, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a scheduling manager 820, a resource determination component 825, and a data communications manager 830. The communications manager 815 may be an example of aspects of the communications manager 1010 described herein.

The scheduling manager 820 may receive DCI from a base station, the DCI including unicast scheduling information for a set of UEs including the first UE.

The resource determination component 825 may determine, from the unicast scheduling information, a set of resources for communicating with the base station.

The data communications manager 830 may communicate with the base station using the set of resources based on the determination.

The transmitter 835 may transmit signals generated by other components of the device 805. In some examples, the transmitter 835 may be collocated with a receiver 810 in a transceiver module. For example, the transmitter 835 may be an example of aspects of the transceiver 1020 described with reference to FIG. 10. The transmitter 835 may utilize a single antenna or a set of antennas.

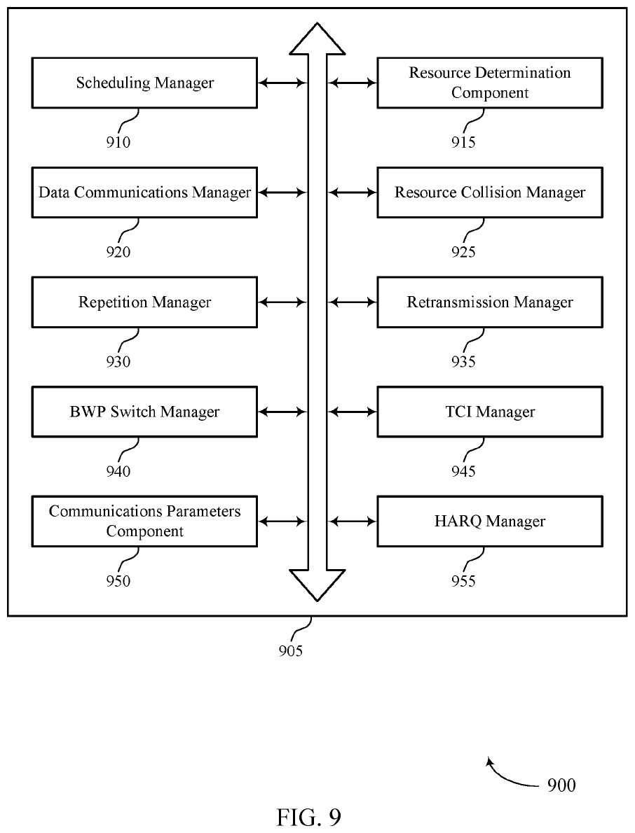

FIG. 9 shows a block diagram 900 of a communications manager 905 that supports DCI for unicast scheduling of multiple UEs in accordance with aspects of the present disclosure. The communications manager 905 may be an example of aspects of a communications manager 715, a communications manager 815, or a communications manager 1010 described herein. The communications manager 905 may include a scheduling manager 910, a resource determination component 915, a data communications manager 920, a resource collision manager 925, a repetition manager 930, a retransmission manager 935, a BWP switch manager 940, a TCI manager 945, a communications parameters component 950, and a HARQ manager 955. Each of these modules may communicate, directly or indirectly, with one another (e.g., via one or more buses).

The scheduling manager 910 may receive DCI from a base station, the DCI including unicast scheduling information for a set of UEs including the first UE.

In some examples, the scheduling manager 910 may decode the DCI based on a CRC of the DCI that is scrambled with a RNTI that is common across the set of UEs.

The resource determination component 915 may determine, from the unicast scheduling information, a set of resources for communicating with the base station.

In some examples, the resource determination component 915 may determine the set of resources based on one or more predefined rules including a UE-specific transformation of time and frequency resources that are common across the set of UEs, where the time and frequency resources are indicated by the DCI.

In some examples, the resource determination component 915 may receive, from the base station, a configuration of the one or more predefined rules, where determining the set of resources is based on the configuration.

In some examples, the resource determination component 915 may calculate the UE-specific transformation based on an identity of the first UE, an index of a table including a set of candidate transformation values, or any combination thereof.

In some cases, the UE-specific transformation includes a shift, a scaling, a modification, or any combination thereof, of the time and frequency resources. In some cases, the UE-specific transformation includes a function that is constant over time, variable over time, or any combination thereof.

The data communications manager 920 may communicate with the base station using the set of resources based on the determination.

In some examples, the data communications manager 920 may identify a configuration of a first scrambling sequence for uplink transmissions of the first UE, the first scrambling sequence being different from a second scrambling sequence of a second UE communicating on the set of resources. In some cases, communicating with the base station includes transmitting an uplink message on the set of resources including a demodulation reference signal scrambled in accordance with the first scrambling sequence.

In some examples, the data communications manager 920 may receive data for the first UE via a physical downlink shared channel. In some examples, the data communications manager 920 may transmit data to the base station via a physical uplink shared channel.

The resource collision manager 925 may receive a message via a physical downlink shared channel based on the set of resources. In some examples, the resource collision manager 925 may attempt to decode the received message using a scrambling sequence that is specific to the first UE.

In some examples, the resource collision manager 925 may determine that decoding of the received message was unsuccessful based on the attempted decoding, the set of resources at least partially colliding with resources for a second UE of the set of UEs, where the received message is for the second UE.

In some examples, the resource collision manager 925 may decode the received message using the scrambling sequence, where the received message is for the first UE. In some examples, the resource collision manager 925 may identify one or more candidate shifts that are specific to the first UE. In some examples, the resource collision manager 925 may determine the set of resources based on the one or more candidate shifts.

In some examples, the resource collision manager 925 may receive, from the base station, a configuration of the one or more candidate shifts, where the one or more candidate shifts are identified based on the configuration.

In some examples, the resource collision manager 925 may identify, within the DCI, a bitmap indicating whether messages for the set of UEs are to be transmitted, the bitmap including respective bit values for each UE of the set of UEs.

In some examples, the resource collision manager 925 may determine that a message for the first UE is to be transmitted on the set of resources based on a bit value from the bitmap that is associated with the first UE.

In some examples, the resource collision manager 925 may identify that the first UE is included in a first UE group from a set of two or more UE groups, where a subset of UEs from the set of UEs included in the first UE group have non-colliding sets of resources. In some examples, the resource collision manager 925 may determine the set of resources based on the first UE being included in the first UE group.

In some examples, the resource collision manager 925 may monitor a physical downlink control channel for the DCI based on the first UE being included in the first UE group, where the DCI is received in a first set of one or more time intervals associated with the first UE group, the first set of one or more time intervals being different from a second set of one or more time intervals associated with a second UE group of the set of two or more UE groups.

In some examples, the resource collision manager 925 may identify, within the DCI, a bitmap indicating that the first UE is included in the first UE group, the bitmap including respective bit values for UEs associated with each UE group of the set of two or more UE groups, where the respective bit values indicate whether messages for the UEs associated with each UE group are to be transmitted.

In some examples, the resource collision manager 925 may identify, within the DCI, a bitmap indicating whether the set of UEs are to transmit messages on respective sets of resources, the bitmap including respective bit values for each UE of the set of UEs.

In some examples, the resource collision manager 925 may determine that the first UE is to transmit a message on the set of resources based on a bit value from the bitmap that is associated with the first UE.

In some examples, the resource collision manager 925 may identify that the first UE is included in a first UE group from a set of two or more UE groups, where a subset of UEs from the set of UEs included in the first UE group have non-colliding sets of resources.

In some examples, determining the set of resources based on being included in the first UE group, where communicating with the base station includes transmitting an uplink message to the base station on the set of resources based on the UE being included in the first UE group.

The repetition manager 930 may refrain from monitoring for a second DCI based on receiving the DCI, where the DCI and the second DCI are associated with scheduling unicast repetitions of a message for the first UE. In some examples, the repetition manager 930 may receive one or more repetitions of the message based on the received DCI and the set of resources.

In some examples, the repetition manager 930 may receive a second DCI, where the DCI and the second DCI are associated with scheduling unicast repetitions of a message for the first UE.

In some examples, the repetition manager 930 may receive one or more repetitions of the message based on the received DCI, the second DCI, and the set of resources.

The retransmission manager 935 may determine, based on a decoding failure of a message received on the set of resources, a second set of resources for a retransmission of the message from the base station, where the second set of resources is different from the set of resources.

In some examples, the retransmission manager 935 may receive a second DCI that schedules the second set of resources for the retransmission, where the second set of resources is based on the second DCI.

In some examples, the retransmission manager 935 may receive the retransmission of the message on the second set of resources, where the message is identified as the retransmission of the message based on decoding the message on the second set of resources.

In some examples, the retransmission manager 935 may refrain from soft combining the message and the retransmission of the message based on the set of resources indicating an initial transmission of the message and the second set of resources indicating the retransmission of the message. In some examples, the retransmission manager 935 may perform a hypothetical soft combining of the message and the retransmission of the message.

In some cases, the set of resources is associated with a first scrambling identifier and the second set of resources is associated with a second scrambling identifier different from the first scrambling identifier, and where the second set of resources is the same as the set of resources. In some cases, the second set of resources is different from the set of resources.

The BWP switch manager 940 may identify a switch from a first bandwidth part to a second bandwidth part based on the DCI, where each UE of the set of UEs are switched to the second bandwidth part.

In some examples, the BWP switch manager 940 may identify a switch from a first bandwidth part to a second bandwidth part based on the DCI, the DCI including a respective bandwidth part identifier field for each UE of the set of UEs, where the switch from the first bandwidth part is identified based on a first bandwidth part identifier field corresponding to the first UE.

In some examples, the BWP switch manager 940 may receive a second DCI including unicast scheduling information for the first UE, the second DCI triggering a switch from a first bandwidth part to a second bandwidth part.

In some examples, the BWP switch manager 940 may switch from the first bandwidth part to the second bandwidth part based on the second DCI.

In some examples, the BWP switch manager 940 may receive a second DCI including information for a group of UEs from the set of UEs, the second DCI triggering a switch from a first bandwidth part to a second bandwidth part for the group of UEs.

In some examples, the BWP switch manager 940 may monitor for the DCI within a set of control resources that are configured across a first bandwidth part and a second bandwidth part. In some examples, the BWP switch manager 940 may switch from the first bandwidth part to the second bandwidth part. In some examples, the BWP switch manager 940 may monitor for the DCI within the set of control resources based on the switching.

In some examples, the BWP switch manager 940 may monitor for the DCI within a first set of control resources that are associated with a first bandwidth part. In some examples, the BWP switch manager 940 may switch from the first bandwidth part to a second bandwidth part.

In some examples, the BWP switch manager 940 may monitor for the DCI within a second set of control resources associated with the second bandwidth part, where the switching is based on the second set of control resources of the second bandwidth part used for the DCI.

The TCI manager 945 may identify a transmission configuration indicator state that indicates quasi co-location information for communicating with the base station, the quasi co-location information being common across a group of UEs from the set of UEs, where the DCI includes a bitmap indicating whether messages for the group of UEs are to be transmitted, and where communicating with the base station is based on the identified transmission configuration indicator state.

The communications parameters component 950 may identify, within the DCI, one or more communications parameters for communicating with the base station, where the one or more communications parameters are indicated within a same field for each UE of the set of UEs.

In some examples, the communications parameters component 950 may determine UE-specific communications parameters in accordance with at least a portion of a table that is based on the one or more communications parameters. In some examples, the communications parameters component 950 may communicate with the base station based on the UE-specific communications parameters.

In some cases, the one or more communications parameters include a modulation and coding scheme, an antenna port, a virtual resource block to physical resource block mapping, a physical uplink control channel resource, feedback timing, rate matching information, a zero power channel state information reference signal trigger, or any combination thereof. In some cases, the DCI excludes a transmit power control field, or a counter downlink assignment index field, or any combination thereof.

The HARQ manager 955 may determine a HARQ process identifier based on a time interval associated with receiving a downlink message from the base station using the set of resources. In some examples, the HARQ manager 955 may transmit a feedback message to the base station based on the HARQ process identifier.

FIG. 10 shows a diagram of a system 1000 including a device 1005 that supports DCI for unicast scheduling of multiple UEs in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may receive DCI from a base station, the DCI including unicast scheduling information for a set of UEs including the first UE, determine, from the unicast scheduling information, a set of resources for communicating with the base station, and communicate with the base station using the set of resources based on the determination.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic input/output system (BIOS) which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting DCI for unicast scheduling of multiple UEs).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

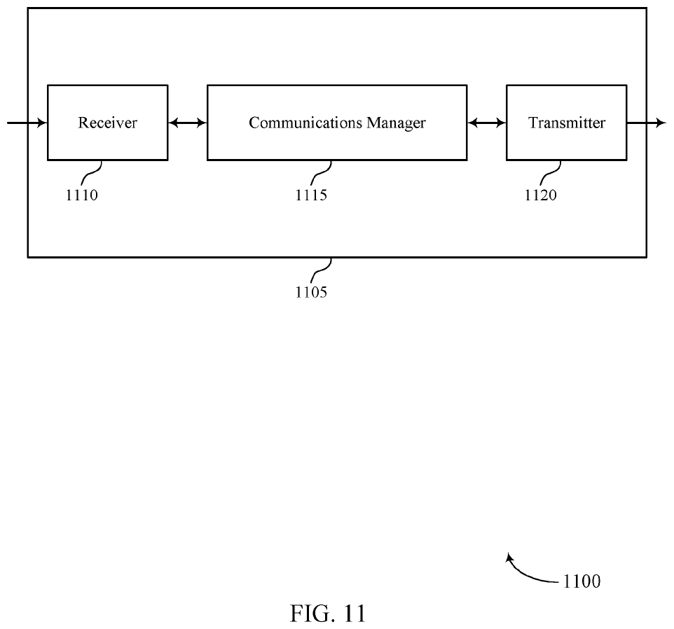

FIG. 11 shows a block diagram 1100 of a device 1105 that supports DCI for unicast scheduling of multiple UEs in accordance with aspects of the present disclosure. The device 1105 may be an example of aspects of a base station 105 as described herein. The device 1105 may include a receiver 1110, a communications manager 1115, and a transmitter 1120. The device 1105 may also include a processor. Each of these components may be in communication with one another (e.g., via one or more buses).

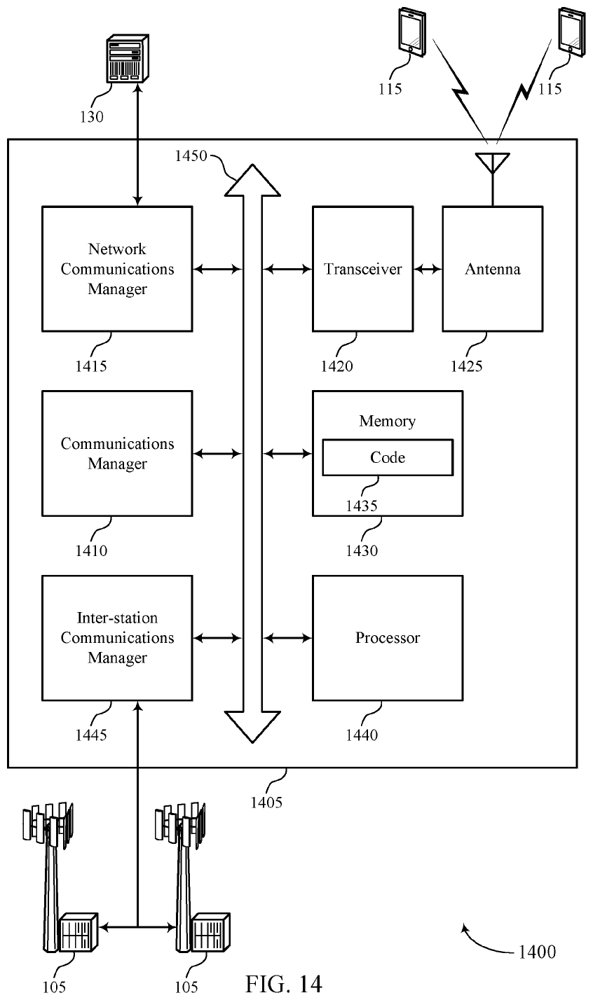

The receiver 1110 may receive information such as packets, user data, or control information associated with various information channels (e.g., control channels, data channels, and information related to DCI for unicast scheduling of multiple UEs, etc.). Information may be passed on to other components of the device 1105. The receiver 1110 may be an example of aspects of the transceiver 1420 described with reference to FIG. 14. The receiver 1110 may utilize a single antenna or a set of antennas.

The communications manager 1115 may transmit DCI to a set of UEs (UEs), the DCI including unicast scheduling information for the set of UEs and communicate with one or more UEs of the set of UEs using respective sets of resources that are determined based on the unicast scheduling information for the set of UEs. The communications manager 1115 may be an example of aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

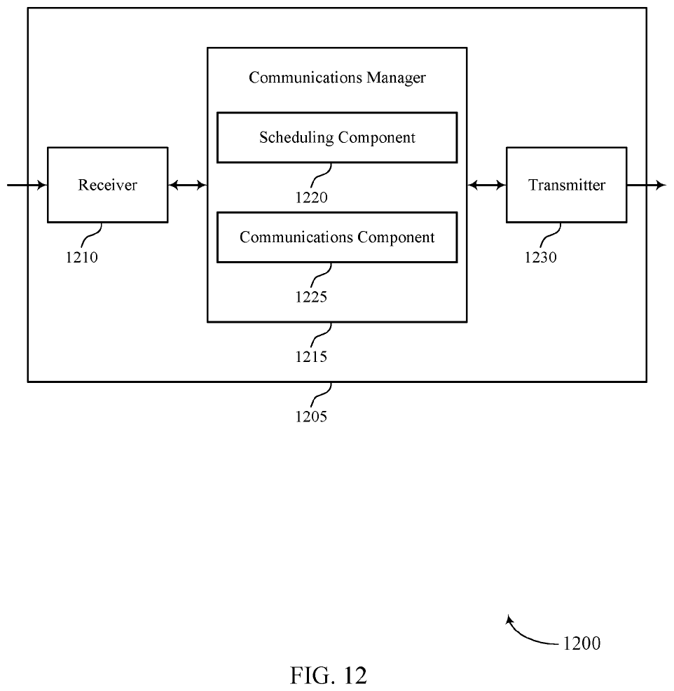

FIG. 12 shows a block diagram 1200 of a device 1205 that supports DCI for unicast scheduling of multiple UEs in accordance with aspects of the present disclosure. The device 1205 may be an example of aspects of a device 1105, or a base station 105 as described herein. The device 1205 may include a receiver 1210, a communications manager 1215, and a transmitter 1230. The device 1205 may also include a processor. Each of these components may be in communication with one another (e.g., via one or more buses).

The receiver 1210 may receive information such as packets, user data, or control information associated with various information channels (e.g., control channels, data channels, and information related to DCI for unicast scheduling of multiple UEs, etc.). Information may be passed on to other components of the device 1205. The receiver 1210 may be an example of aspects of the transceiver 1420 described with reference to FIG. 14. The receiver 1210 may utilize a single antenna or a set of antennas.

The communications manager 1215 may be an example of aspects of the communications manager 1115 as described herein. The communications manager 1215 may include a scheduling component 1220 and a communications component 1225. The communications manager 1215 may be an example of aspects of the communications manager 1410 described herein.

The scheduling component 1220 may transmit DCI to a set of UEs (UEs), the DCI including unicast scheduling information for the set of UEs.

The communications component 1225 may communicate with one or more UEs of the set of UEs using respective sets of resources that are determined based on the unicast scheduling information for the set of UEs.

The transmitter 1230 may transmit signals generated by other components of the device 1205. In some examples, the transmitter 1230 may be collocated with a receiver 1210 in a transceiver module. For example, the transmitter 1230 may be an example of aspects of the transceiver 1420 described with reference to FIG. 14. The transmitter 1230 may utilize a single antenna or a set of antennas.

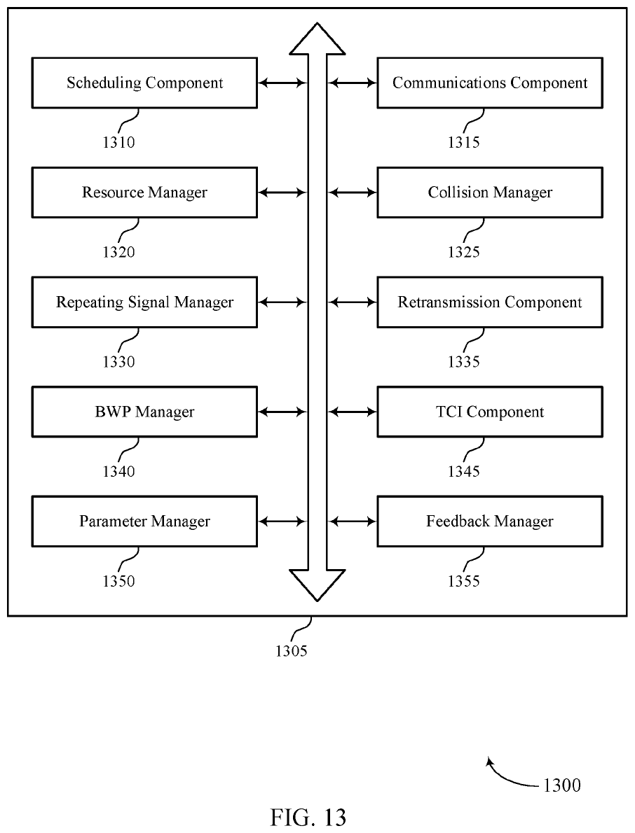

FIG. 13 shows a block diagram 1300 of a communications manager 1305 that supports DCI for unicast scheduling of multiple UEs in accordance with aspects of the present disclosure. The communications manager 1305 may be an example of aspects of a communications manager 1115, a communications manager 1215, or a communications manager 1410 described herein. The communications manager 1305 may include a scheduling component 1310, a communications component 1315, a resource manager 1320, a collision manager 1325, a repeating signal manager 1330, a retransmission component 1335, a BWP manager 1340, a TCI component 1345, a parameter manager 1350, and a feedback manager 1355. Each of these modules may communicate, directly or indirectly, with one another (e.g., via one or more buses).

The scheduling component 1310 may transmit DCI to a set of UEs (UEs), the DCI including unicast scheduling information for the set of UEs.

In some examples, the scheduling component 1310 may scramble a CRC of the DCI based using a RNTI that is common across the set of UEs.

The communications component 1315 may communicate with one or more UEs of the set of UEs using respective sets of resources that are determined based on the unicast scheduling information for the set of UEs.

In some examples, the communications component 1315 may transmit, to a first UE of the one or more UEs, a first configuration of a first scrambling sequence for transmissions of the first UE.

In some examples, the communications component 1315 may transmit, to a second UE of the one or more UEs, a second configuration of a second scrambling sequence for transmissions of the second UE, the second scrambling sequence being different from the first scrambling sequence.

In some examples, the communications component 1315 may receive a first uplink message from the first UE and a second uplink message from the second UE on the set of resources, the first uplink message including a first demodulation reference signal scrambled in accordance with the first scrambling sequence, and the second uplink message including a second demodulation reference signal scrambled in accordance with the second scrambling sequence.

In some examples, the communications component 1315 may transmit data to the one or more UEs via a physical downlink shared channel.

In some examples, the communications component 1315 may receive data from the one or more UEs via a physical uplink shared channel.

The resource manager 1320 may determine a set of resources for communicating with a first UE of the one or more UEs based on one or more predefined rules including a UE-specific transformation of time and frequency resources that are common across the set of UEs, where the time and frequency resources are indicated by the DCI.

In some examples, the resource manager 1320 may transmit, to the first UE, a configuration of the one or more predefined rules. In some examples, the resource manager 1320 may determine the set of resources for communicating with the first UE based on the configuration.

In some examples, the resource manager 1320 may determine the UE-specific transformation based on an identity of the first UE, an index of a table including a set of candidate transformation values, or any combination thereof.

In some cases, the UE-specific transformation includes a shift, a scaling, a modification, or any combination thereof, of the time and frequency resources. In some cases, the UE-specific transformation includes a function that is constant over time, variable over time, or any combination thereof.

The collision manager 1325 may transmit, to a first UE of the one or more UEs, a message via a physical downlink shared channel based on a first set of resources for the first UE, where the message is scrambled using a scrambling sequence that is specific to the first UE.

In some examples, the collision manager 1325 may refrain from transmitting to other UEs of the one or more UEs based on a collision between the first set of resources and respective sets of resources for the other UEs. In some examples, the collision manager 1325 may identify one or more candidate shifts that are specific to a first UE of the one or more UEs.

In some examples, the collision manager 1325 may transmit, to the first UE, a configuration of the one or more candidate shifts, where a set of resources for communicating with the first UE is based on the one or more candidate shifts.

In some examples, the collision manager 1325 may transmit, within the DCI, a bitmap indicating whether messages for the set of UEs are to be transmitted, the bitmap including respective bit values for each UE of the set of UEs.

In some examples, the collision manager 1325 may indicate, to a first UE of the one or more UES, that a message for the first UE is to be transmitted on a set of resources based on a bit value from the bitmap that is associated with the first UE.

In some examples, the collision manager 1325 may identify that a first UE of the one or more UEs is included in a first UE group from a set of two or more UE groups, where a subset of UEs from the set of UEs included in the first UE group have non-colliding sets of resources. In some examples, the collision manager 1325 may determine a set of resources for communicating with the first UE based on the first UE being included in the first UE group.

In some examples, the collision manager 1325 may transmit the DCI via a physical downlink control channel based on the first UE being included in the first UE group, where the DCI is transmitted in a first set of one or more time intervals associated with the first UE group, the first set of one or more time intervals being different from a second set of one or more time intervals associated with a second UE group of the set of two or more UE groups.

In some examples, the collision manager 1325 may transmit, within the DCI, a bitmap indicating that the first UE is included in the first UE group, the bitmap including respective bit values for UEs associated with each UE group of the set of two or more UE groups, where the respective bit values indicate whether messages for the UEs associated with each UE group are to be transmitted.

In some examples, the collision manager 1325 may transmit, within the DCI, a bitmap indicating whether the set of UEs are to transmit messages on respective sets of resources, the bitmap including respective bit values for each UE of the set of UEs, where communicating with the one or more UEs is based on the respective bit values.

In some examples, determining a set of resources associated with the first UE for receiving uplink messages based on the first UE being included in the first UE group, where communicating with the one or more UEs includes receiving an uplink message from the first UE on the set of resources.

The repeating signal manager 1330 may transmit, to a first UE of the one or more UEs, one or more repetitions of a message based on the DCI and a set of resources associated with the first UE, the DCI scheduling unicast repetitions of the message for the first UE.

In some examples, the repeating signal manager 1330 may transmit a second DCI to a first UE of the one or more UEs, where the DCI and the second DCI are associated with scheduling unicast repetitions of a message for the first UE.

In some examples, the repeating signal manager 1330 may transmit one or more repetitions of the message based on the DCI, the second DCI, and a set of resources associated with the first UE.

The retransmission component 1335 may determine, based on a decoding failure of a message transmitted on a first set of resources for a first UE of the one or more UEs, a second set of resources for a retransmission of the message, where the second set of resources is different from the first set of resources.

In some examples, the retransmission component 1335 may transmit a second DCI that schedules the second set of resources for the retransmission, where the second set of resources is based on the second DCI.

In some examples, the retransmission component 1335 may transmit the retransmission of the message on the second set of resources, where the message is identified as the retransmission of the message based on transmitting the message on the second set of resources.

In some cases, the set of resources is associated with a first scrambling identifier and the second set of resources is associated with a second scrambling identifier different from the first scrambling identifier, and where the second set of resources is the same as the set of resources. In some cases, the second set of resources is different from the set of resources.

The BWP manager 1340 may trigger, for each UE of the set of UEs, a switch from a first bandwidth part to a second bandwidth part based on the DCI.

In some examples, the BWP manager 1340 may trigger, for a first UE of the set of UEs, a switch from a first bandwidth part to a second bandwidth part based on the DCI, the DCI including a respective bandwidth part identifier field for each UE of the set of UEs, where the switch from the first bandwidth part is identified based on a first bandwidth part identifier field corresponding to the first UE.

In some examples, the BWP manager 1340 may transmit a second DCI including unicast scheduling information for a first UE of the one or more UEs, the second DCI triggering a switch of the first UE from a first bandwidth part to a second bandwidth part.

In some examples, the BWP manager 1340 may transmit, to a first UE of the one or more UEs, a second DCI including information for a group of UEs from the set of UEs, the second DCI triggering a switch from a first bandwidth part to a second bandwidth part for the group of UEs.

In some examples, the BWP manager 1340 may transmit, to a subset of UEs from the set of UEs, a second DCI including unicast scheduling information for the set of UEs, the second DCI transmitted within a second set of control resources associated with a second bandwidth part, where the subset of UEs are switched to the second bandwidth part based on the second set of control resources of the second bandwidth part used for the second DCI. In some cases, the DCI is transmitted within a set of control resources that are configured across a first bandwidth part and a second bandwidth part.

The TCI component 1345 may configure a transmission configuration indicator state that indicates quasi co-location information, the quasi co-location information being common across a group of UEs from the set of UEs, where the DCI includes a bitmap indicating whether messages for the group of UEs are to be transmitted, and where communicating with the one or more UEs is based on the configured transmission configuration indicator state.

The parameter manager 1350 may transmit, within the DCI, one or more communications parameters for communicating with the base station, where the one or more communications parameters are indicated within a same field for each UE of the set of UEs, where UE-specific communications parameters for communicating with respective UEs are based on at least a portion of a table associated with the one or more communications parameters.

In some cases, the one or more communications parameters include a modulation and coding scheme, an antenna port, a virtual resource block to physical resource block mapping, a physical uplink control channel resource, feedback timing, rate matching information, a zero power channel state information reference signal trigger, or any combination thereof. In some cases, the DCI excludes a transmit power control field, or a counter downlink assignment index field, or any combination thereof.

The feedback manager 1355 may receive, from a first UE of the one or more UEs, a feedback message in accordance with a HARQ process identifier that is based on a time interval associated with transmitting a downlink message using a set of resources associated with the first UE.

FIG. 14 shows a diagram of a system 1400 including a device 1405 that supports DCI for unicast scheduling of multiple UEs in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a communications manager 1410, a network communications manager 1415, a transceiver 1420, an antenna 1425, memory 1430, a processor 1440, and an inter-station communications manager 1445. These components may be in electronic communication via one or more buses (e.g., bus 1450).

The communications manager 1410 may transmit DCI to a set of UEs (UEs), the DCI including unicast scheduling information for the set of UEs and communicate with one or more UEs of the set of UEs using respective sets of resources that are determined based on the unicast scheduling information for the set of UEs.

The network communications manager 1415 may manage communications with the core network (e.g., via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described herein. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (e.g., the processor 1440) cause the device to perform various functions described herein. In some cases, the memory 1430 may contain, among other things, a BIOS which may control basic hardware or software operation such as the interaction with peripheral components or devices.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some cases, a memory controller may be integrated into processor 1440. The processor 1440 may be configured to execute computer-readable instructions stored in a memory (e.g., the memory 1430) to cause the device 1405 to perform various functions (e.g., functions or tasks supporting DCI for unicast scheduling of multiple UEs).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

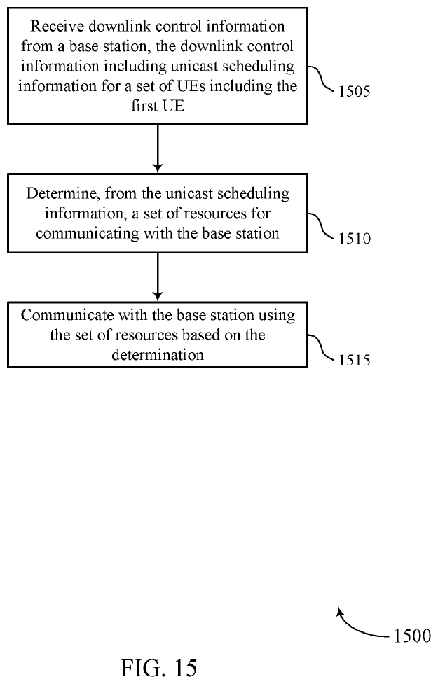

FIG. 15 shows a flowchart illustrating a method 1500 that supports DCI for unicast scheduling of multiple UEs in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1505, the UE may receive DCI from a base station, the DCI including unicast scheduling information for a set of UEs including the first UE. The operations of 1505 may be performed according to the methods described herein. In some examples, aspects of the operations of 1505 may be performed by a scheduling manager as described with reference to FIGS. 7 through 10.

At 1510, the UE may determine, from the unicast scheduling information, a set of resources for communicating with the base station. The operations of 1510 may be performed according to the methods described herein. In some examples, aspects of the operations of 1510 may be performed by a resource determination component as described with reference to FIGS. 7 through 10.

At 1515, the UE may communicate with the base station using the set of resources based on the determination. The operations of 1515 may be performed according to the methods described herein. In some examples, aspects of the operations of 1515 may be performed by a data communications manager as described with reference to FIGS. 7 through 10.

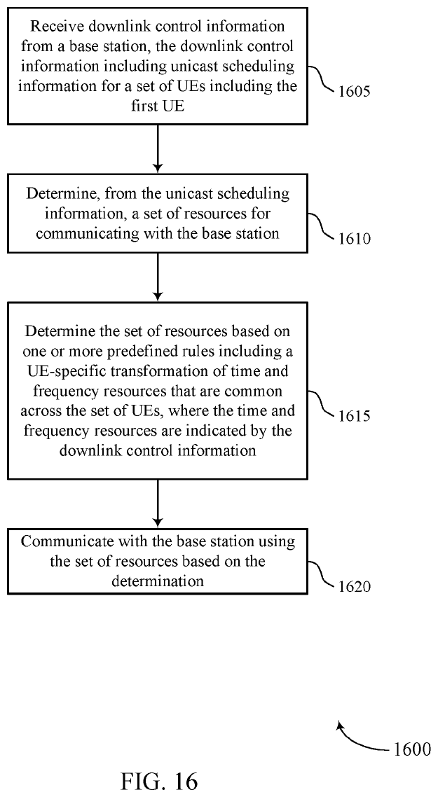

FIG. 16 shows a flowchart illustrating a method 1600 that supports DCI for unicast scheduling of multiple UEs in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1605, the UE may receive DCI from a base station, the DCI including unicast scheduling information for a set of UEs including the first UE. The operations of 1605 may be performed according to the methods described herein. In some examples, aspects of the operations of 1605 may be performed by a scheduling manager as described with reference to FIGS. 7 through 10.

At 1610, the UE may determine, from the unicast scheduling information, a set of resources for communicating with the base station. The operations of 1610 may be performed according to the methods described herein. In some examples, aspects of the operations of 1610 may be performed by a resource determination component as described with reference to FIGS. 7 through 10.

At 1615, the UE may determine the set of resources based on one or more predefined rules including a UE-specific transformation of time and frequency resources that are common across the set of UEs, where the time and frequency resources are indicated by the DCI. The operations of 1615 may be performed according to the methods described herein. In some examples, aspects of the operations of 1615 may be performed by a resource determination component as described with reference to FIGS. 7 through 10.

At 1620, the UE may communicate with the base station using the set of resources based on the determination. The operations of 1620 may be performed according to the methods described herein. In some examples, aspects of the operations of 1620 may be performed by a data communications manager as described with reference to FIGS. 7 through 10.

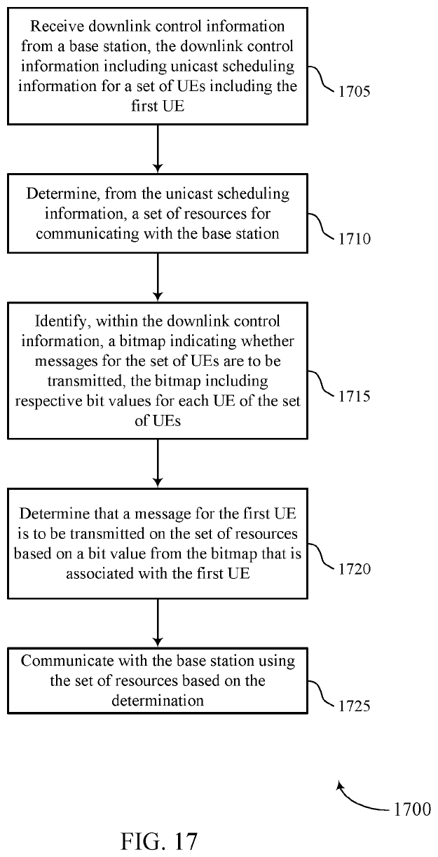

FIG. 17 shows a flowchart illustrating a method 1700 that supports DCI for unicast scheduling of multiple UEs in accordance with aspects of the present disclosure. The operations of method 1700 may be implemented by a UE 115 or its components as described herein. For example, the operations of method 1700 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1705, the UE may receive DCI from a base station, the DCI including unicast scheduling information for a set of UEs including the first UE. The operations of 1705 may be performed according to the methods described herein. In some examples, aspects of the operations of 1705 may be performed by a scheduling manager as described with reference to FIGS. 7 through 10.

At 1710, the UE may determine, from the unicast scheduling information, a set of resources for communicating with the base station. The operations of 1710 may be performed according to the methods described herein. In some examples, aspects of the operations of 1710 may be performed by a resource determination component as described with reference to FIGS. 7 through 10.

At 1715, the UE may identify, within the DCI, a bitmap indicating whether messages for the set of UEs are to be transmitted, the bitmap including respective bit values for each UE of the set of UEs. The operations of 1715 may be performed according to the methods described herein. In some examples, aspects of the operations of 1715 may be performed by a resource collision manager as described with reference to FIGS. 7 through 10.

At 1720, the UE may determine that a message for the first UE is to be transmitted on the set of resources based on a bit value from the bitmap that is associated with the first UE. The operations of 1720 may be performed according to the methods described herein. In some examples, aspects of the operations of 1720 may be performed by a resource collision manager as described with reference to FIGS. 7 through 10.

At 1725, the UE may communicate with the base station using the set of resources based on the determination. The operations of 1725 may be performed according to the methods described herein. In some examples, aspects of the operations of 1725 may be performed by a data communications manager as described with reference to FIGS. 7 through 10.

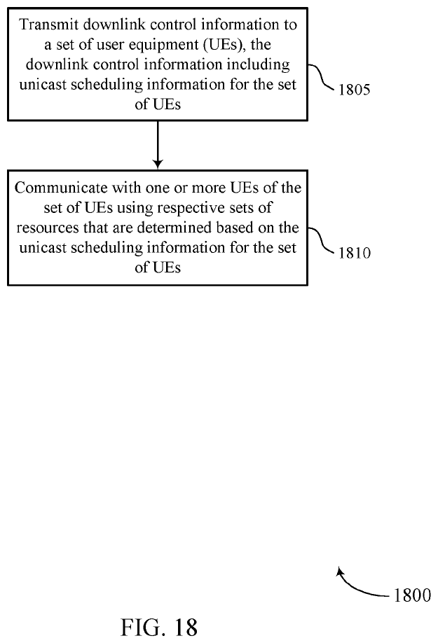

FIG. 18 shows a flowchart illustrating a method 1800 that supports DCI for unicast scheduling of multiple UEs in accordance with aspects of the present disclosure. The operations of method 1800 may be implemented by a base station 105 or its components as described herein. For example, the operations of method 1800 may be performed by a communications manager as described with reference to FIGS. 11 through 14. In some examples, a base station may execute a set of instructions to control the functional elements of the base station to perform the functions described herein. Additionally or alternatively, a base station may perform aspects of the functions described herein using special-purpose hardware.

At 1805, the base station may transmit DCI to a set of UEs, the DCI including unicast scheduling information for the set of UEs. The operations of 1805 may be performed according to the methods described herein. In some examples, aspects of the operations of 1805 may be performed by a scheduling component as described with reference to FIGS. 11 through 14.

At 1810, the base station may communicate with one or more UEs of the set of UEs using respective sets of resources that are determined based on the unicast scheduling information for the set of UEs. The operations of 1810 may be performed according to the methods described herein. In some examples, aspects of the operations of 1810 may be performed by a communications component as described with reference to FIGS. 11 through 14.

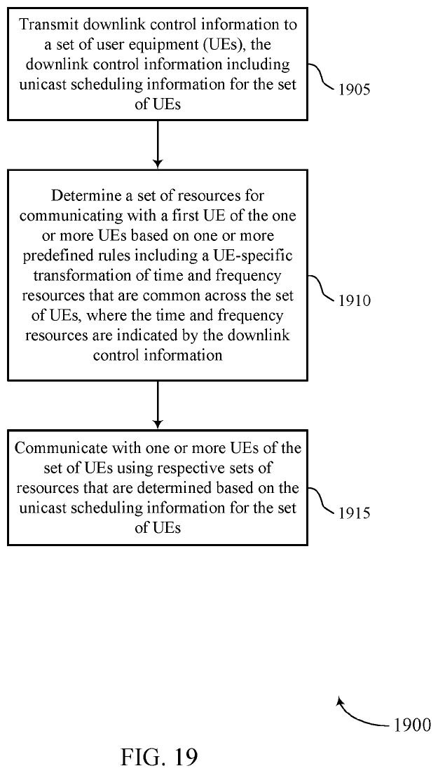

FIG. 19 shows a flowchart illustrating a method 1900 that supports DCI for unicast scheduling of multiple UEs in accordance with aspects of the present disclosure. The operations of method 1900 may be implemented by a base station 105 or its components as described herein. For example, the operations of method 1900 may be performed by a communications manager as described with reference to FIGS. 11 through 14. In some examples, a base station may execute a set of instructions to control the functional elements of the base station to perform the functions described herein. Additionally or alternatively, a base station may perform aspects of the functions described herein using special-purpose hardware.

At 1905, the base station may transmit DCI to a set of UEs, the DCI including unicast scheduling information for the set of UEs. The operations of 1905 may be performed according to the methods described herein. In some examples, aspects of the operations of 1905 may be performed by a scheduling component as described with reference to FIGS. 11 through 14.

At 1910, the base station may determine a set of resources for communicating with a first UE of the one or more UEs based on one or more predefined rules including a UE-specific transformation of time and frequency resources that are common across the set of UEs, where the time and frequency resources are indicated by the DCI. The operations of 1910 may be performed according to the methods described herein. In some examples, aspects of the operations of 1910 may be performed by a resource manager as described with reference to FIGS. 11 through 14.

At 1915, the base station may communicate with one or more UEs of the set of UEs using respective sets of resources that are determined based on the unicast scheduling information for the set of UEs. The operations of 1915 may be performed according to the methods described herein. In some examples, aspects of the operations of 1915 may be performed by a communications component as described with reference to FIGS. 11 through 14.

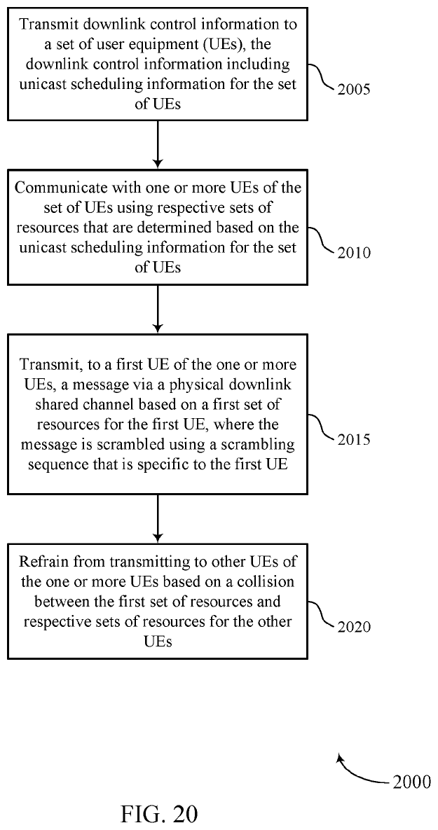

FIG. 20 shows a flowchart illustrating a method 2000 that supports DCI for unicast scheduling of multiple UEs in accordance with aspects of the present disclosure. The operations of method 2000 may be implemented by a base station 105 or its components as described herein. For example, the operations of method 2000 may be performed by a communications manager as described with reference to FIGS. 11 through 14. In some examples, a base station may execute a set of instructions to control the functional elements of the base station to perform the functions described herein. Additionally or alternatively, a base station may perform aspects of the functions described herein using special-purpose hardware.

At 2005, the base station may transmit DCI to a set of UEs, the DCI including unicast scheduling information for the set of UEs. The operations of 2005 may be performed according to the methods described herein. In some examples, aspects of the operations of 2005 may be performed by a scheduling component as described with reference to FIGS. 11 through 14.

At 2010, the base station may communicate with one or more UEs of the set of UEs using respective sets of resources that are determined based on the unicast scheduling information for the set of UEs. The operations of 2010 may be performed according to the methods described herein. In some examples, aspects of the operations of 2010 may be performed by a communications component as described with reference to FIGS. 11 through 14.

At 2015, the base station may transmit, to a first UE of the one or more UEs, a message via a physical downlink shared channel based on a first set of resources for the first UE, where the message is scrambled using a scrambling sequence that is specific to the first UE. The operations of 2015 may be performed according to the methods described herein. In some examples, aspects of the operations of 2015 may be performed by a collision manager as described with reference to FIGS. 11 through 14.

At 2020, the base station may refrain from transmitting to other UEs of the one or more UEs based on a collision between the first set of resources and respective sets of resources for the other UEs. The operations of 2020 may be performed according to the methods described herein. In some examples, aspects of the operations of 2020 may be performed by a collision manager as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1-77. (canceled)

78. An apparatus for wireless communication at a first user equipment (UE), comprising:
at least one processor,
memory coupled with the at least one processor, the memory storing instructions for the at least one processor to cause the UE to:
receive downlink control information from a network device, the downlink control information comprising unicast scheduling information for a plurality of UEs including the first UE;
determine, from the unicast scheduling information, a set of resources for communicating with the network device; and
communicate with the network device using the set of resources based at least in part on the determination.

79. The apparatus of claim 78, wherein the instructions to determine the set of resources are for the at least one processor to cause the apparatus to:
determine the set of resources based at least in part on one or more predefined rules comprising a UE-specific transformation of time and frequency resources that are common across the plurality of UEs, wherein the time and frequency resources are indicated by the downlink control information.

80. (canceled)

81. The apparatus of claim 79, wherein the instructions are further for the at least one processor to cause the apparatus to:
receive, from the network device, a configuration of the one or more predefined rules, wherein determining the set of resources is based at least in part on the configuration.

82. The apparatus of claim 79, wherein the instructions are further for the at least one processor to cause the apparatus to:
calculate the UE-specific transformation based at least in part on an identity of the first UE, an index of a table including a set of candidate transformation values, or any combination thereof.

83. (canceled)

84. The apparatus of claim 78, wherein the instructions are further for the at least one processor to cause the apparatus to:
receive a message via a physical downlink shared channel based at least in part on the set of resources; and
attempt to decode the received message using a scrambling sequence that is specific to the first UE.

85. (canceled)

86. (canceled)

87. The apparatus of claim 78, wherein the instructions to determine the set of resources are for the at least one processor to cause the apparatus to:
identify one or more candidate shifts that are specific to the first UE; and
determine the set of resources based at least in part on the one or more candidate shifts.

88. (canceled)

89. The apparatus of claim 78, wherein the instructions to determine the set of resources are for the at least one processor to cause the apparatus to:
identify, within the downlink control information, a bitmap indicating whether messages for the plurality of UEs are to be transmitted, the bitmap comprising respective bit values for each UE of the plurality of UEs; and
determine that a message for the first UE is to be transmitted on the set of resources based at least in part on a bit value from the bitmap that is associated with the first UE.

90. The apparatus of claim 78, wherein the instructions to determine the set of resources are for the at least one processor to cause the apparatus to:
identify that the first UE is included in a first UE group from a set of two or more UE groups, wherein a subset of UEs from the plurality of UEs included in the first UE group have non-colliding sets of resources; and
determine the set of resources based at least in part on the first UE being included in the first UE group.

91. (canceled)

92. (canceled)

93. The apparatus of claim 78, wherein the instructions are further for the at least one processor to cause the apparatus to:
refrain from monitoring for a second downlink control information based at least in part on receiving the downlink control information, wherein the downlink control information and the second downlink control information are associated with scheduling unicast repetitions of a message for the first UE; and
receive one or more repetitions of the message based at least in part on the received downlink control information and the set of resources.

94. The apparatus of claim 78, wherein the instructions are further for the at least one processor to cause the apparatus to:
receive a second downlink control information, wherein the downlink control information and the second downlink control information are associated with scheduling unicast repetitions of a message for the first UE; and
receive one or more repetitions of the message based at least in part on the received downlink control information, the second downlink control information, and the set of resources.

95. The apparatus of claim 78, wherein the instructions are further for the at least one processor to cause the apparatus to:
determine, based at least in part on a decoding failure of a message received on the set of resources, a second set of resources for a retransmission of the message from the network device, wherein the second set of resources is different from the set of resources.

96-101. (canceled)

102. The apparatus of claim 78, wherein the instructions are further for the at least one processor to cause the apparatus to:
identify a switch from a first bandwidth part to a second bandwidth part based at least in part on the downlink control information, wherein each UE of the plurality of UEs are switched to the second bandwidth part.

103. The apparatus of claim 78, wherein the instructions are further for the at least one processor to cause the apparatus to:
identify a switch from a first bandwidth part to a second bandwidth part based at least in part on the downlink control information, the downlink control information comprising a respective bandwidth part identifier field for each UE of the plurality of UEs, wherein the switch from the first bandwidth part is identified based on a first bandwidth part identifier field corresponding to the first UE.

104. The apparatus of claim 78, wherein the instructions are further for the at least one processor to cause the apparatus to:
receive a second downlink control information comprising unicast scheduling information for the first UE, the second downlink control information triggering a switch from a first bandwidth part to a second bandwidth part; and
switch from the first bandwidth part to the second bandwidth part based at least in part on the second downlink control information.

105. The apparatus of claim 78, wherein the instructions are further for the at least one processor to cause the apparatus to:
receive a second downlink control information comprising information for a group of UEs from the plurality of UEs, the second downlink control information triggering a switch from a first bandwidth part to a second bandwidth part for the group of UEs; and
switch from the first bandwidth part to the second bandwidth part based at least in part on the second downlink control information.

106. The apparatus of claim 78, wherein the instructions are further for the at least one processor to cause the apparatus to:
monitor for the downlink control information within a set of control resources that are configured across a first bandwidth part and a second bandwidth part;
switch from the first bandwidth part to the second bandwidth part; and
monitor for the downlink control information within the set of control resources based at least in part on the switching.

107. The apparatus of claim 78, wherein the instructions are further for the at least one processor to cause the apparatus to:
monitor for the downlink control information within a first set of control resources that are associated with a first bandwidth part;
switch from the first bandwidth part to a second bandwidth part; and
monitor for the downlink control information within a second set of control resources associated with the second bandwidth part, wherein the switching is based at least in part on the second set of control resources of the second bandwidth part used for the downlink control information.

108. The apparatus of claim 78, wherein the instructions are further for the at least one processor to cause the apparatus to:
identify a transmission configuration indicator state that indicates quasi co-location information for communicating with the network device, the quasi co-location information being common across a group of UEs from the plurality of UEs, wherein the downlink control information comprises a bitmap indicating whether messages for the group of UEs are to be transmitted, and wherein communicating with the network device is based at least in part on the identified transmission configuration indicator state.

109. The apparatus of claim 78, wherein the instructions are further for the at least one processor to cause the apparatus to:
identify, within the downlink control information, one or more communications parameters for communicating with the network device, wherein the one or more communications parameters are indicated within a same field for each UE of the plurality of UEs;
determine UE-specific communications parameters in accordance with at least a portion of a table that is based at least in part on the one or more communications parameters; and
communicate with the network device based at least in part on the UE-specific communications parameters.

110. (canceled)

111. (canceled)

112. The apparatus of claim 78, wherein the instructions to determine the set of resources are for the at least one processor to cause the apparatus to:
identify, within the downlink control information, a bitmap indicating whether the plurality of UEs are to transmit messages on respective sets of resources, the bitmap comprising respective bit values for each UE of the plurality of UEs; and
determine that the first UE is to transmit a message on the set of resources based at least in part on a bit value from the bitmap that is associated with the first UE.

113. The apparatus of claim 78, wherein the instructions to determine the set of resources are for the at least one processor to cause the apparatus to:
identify that the first UE is included in a first UE group from a set of two or more UE groups, wherein a subset of UEs from the plurality of UEs included in the first UE group have non-colliding sets of resources; and
the instructions to determine the set of resources based at least in part on being included in the first UE group, wherein communicating with the network device are executable by the processor to cause the apparatus to transmit an uplink message to the network device on the set of resources based at least in part on the UE being included in the first UE group.

114. The apparatus of claim 78, wherein the instructions to determine the set of resources are for the at least one processor to cause the apparatus to:
identify a configuration of a first scrambling sequence for uplink transmissions of the first UE, the first scrambling sequence being different from a second scrambling sequence of a second UE communicating on the set of resources, wherein the instructions to communicate with the network device comprise instructions executable by the at least one processor to cause the apparatus to:
transmit an uplink message on the set of resources including a demodulation reference signal scrambled in accordance with the first scrambling sequence.

115. The apparatus of claim 78, wherein the instructions are further for the at least one processor to cause the apparatus to:
determine a hybrid automatic repeat request (HARQ) process identifier based at least in part on a time interval associated with receiving a downlink message from the network device using the set of resources; and
transmit a feedback message to the network device based at least in part on the HARQ process identifier.

116-118. (canceled)

119. An apparatus for wireless communication at a network device, comprising:
at least one processor,
memory coupled with the at least one processor, the memory storing instructions for the at least one processor to cause the network device to:
transmit downlink control information to a plurality of user equipment (UEs), the downlink control information comprising unicast scheduling information for the plurality of UEs; and
communicate with one or more UEs of the plurality of UEs using respective sets of resources that are determined based at least in part on the unicast scheduling information for the plurality of UEs.

120. The apparatus of claim 119, wherein the instructions are further for the at least one processor to cause the apparatus to:
determine a set of resources for communicating with a first UE of the one or more UEs based at least in part on one or more predefined rules comprising a UE-specific transformation of time and frequency resources that are common across the plurality of UEs, wherein the time and frequency resources are indicated by the downlink control information.

121-124. (canceled)

125. The apparatus of claim 119, wherein the instructions are further for the at least one processor to cause the apparatus to:
transmit, to a first UE of the one or more UEs, a message via a physical downlink shared channel based at least in part on a first set of resources for the first UE, wherein the message is scrambled using a scrambling sequence that is specific to the first UE; and
refrain from transmitting to other UEs of the one or more UEs based at least in part on a collision between the first set of resources and respective sets of resources for the other UEs.

126-158. (canceled)

159. A method for wireless communication at a first user equipment (UE), comprising:
receiving downlink control information from a network device, the downlink control information comprising unicast scheduling information for a plurality of UEs including the first UE;
determining, from the unicast scheduling information, a set of resources for communicating with the network device; and
communicating with the network device using the set of resources based at least in part on the determination.

160. The method of claim 159, wherein determining the set of resources comprises:
determining the set of resources based at least in part on one or more predefined rules comprising a UE-specific transformation of time and frequency resources that are common across the plurality of UEs, wherein the time and frequency resources are indicated by the downlink control information.

161. A method for wireless communication at a network device, comprising:
transmitting downlink control information to a plurality of user equipment (UEs), the downlink control information comprising unicast scheduling information for the plurality of UEs; and
communicating with one or more UEs of the plurality of UEs using respective sets of resources that are determined based at least in part on the unicast scheduling information for the plurality of UEs.

162. The method of claim 161, further comprising:
determining a set of resources for communicating with a first UE of the one or more UEs based at least in part on one or more predefined rules comprising a UE-specific transformation of time and frequency resources that are common across the plurality of UEs, wherein the time and frequency resources are indicated by the downlink control information.
